(19) United States
(12) Patent Application Publication
(10) Pub. No.: US 2020/0232806 A1
(43) Pub. Date: Jul. 23, 2020

(54) LOCAL MAP SERVER AND MULTIPLEXER

(71) Applicant: Uber Technologies, Inc, San Francisco, CA (US)

(72) Inventors: Max Arcus Goldman, Pittsburgh, PA (US); Kuan-Chieh Chen, Cupertino, CA (US)

(21) Appl. No.: 16/536,925

(22) Filed: Aug. 9, 2019

Related U.S. Application Data
(60) Provisional application No. 62/795,728, filed on Jan. 23, 2019.

(51) Int. Cl. G01C 21/36; G01C 21/34; G05D 1/00; G06K 9/00

(52) U.S. Cl. CPC G01C 21/367; G01C 21/3658; G06F 9/541; G05D 1/0088; G06K 9/00798; G01C 21/3446

(57) ABSTRACT

A system for providing map data to a vehicle includes a map relative pose dependent server that is responsive to map requests from an API. The server generates submaps from static map data based on pose and/or route information for the vehicle, and sensors provide environmental data that is converted into perceived local map data by generating a perceived lane graph from lanes detected by the sensors. A multiplexer enables selection of the generated submaps and/or the perceived maps in response to a map request. The multiplexer compares the generated submaps and the perceived map in response to a map request and provides the perceived map when the generated submaps do not match the perceived map. The multiplexer also may merge the generated submaps and the perceived lane graph in response to the map request.

### CROSS-REFERENCE TO RELATED APPLICATIONS

This application claims the benefit of priority of U.S. Provisional Patent Application Ser. No. 62/795,728, filed Jan. 23, 2019, the contents of which are hereby incorporated by reference for all purposes.

### TECHNICAL FIELD

The disclosure herein is directed to devices, systems, and methods for providing contextual map data to an autonomous or semi-autonomous vehicle.

### BACKGROUND

In conventional AV control systems, the AV control systems are complex distributed systems spread across multiple processes where each autonomy system independently loads maps and queries the map data. This is inefficient because each individual process does the redundant work of identifying relevant map data and then caching that map data for subsequent accesses. Also, the map API is not aware of access patterns for querying the map and users typically cannot query the map in a synchronized manner. In practice, these issues are tightly coupled since being aware of query access patterns requires knowledge of where the AV is, where it came from, and where it is going, while exposing the map build artifacts requires that the AV's location be defined in terms of map build artifacts. AV control modules lack coordination on map access, leading to inefficient, and incorrect, querying of the map.

Also, the API of the autonomy stack accesses respective hard disks and/or solid-state drives on the vehicle containing static vehicle maps. Since this access is in the critical path of the autonomy stack, the map data on the hard disks and/or solid-state drives may be stored in respective local caches for the autonomy sub-modules in the sensor-input to vehicle controls critical path to minimize the number of accesses to disk and the resultant impact on latency. Maintaining multiple caches is not only inefficient but also does not permit any manageable way to insert map data generated from real-time sensor input when the static map data becomes unreliable.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment including an autonomous or semi-autonomous vehicle having a pose system.

FIG. 2 is a block diagram showing one example of an autonomous vehicle according to example aspects of the present disclosure.

FIG. 3 illustrates a map relative pose dependent architecture for providing local map data to the AV stack in sample embodiments.

FIG. 4 illustrates a modified embodiment of the architecture of FIG. 3 that includes a data source abstraction including static map data and a map partition server that provides submaps as a response to a map request.

FIG. 5 illustrates a sample route segment where the AV requires a route from the leftmost lanes to the rightmost lanes so use in illustrating how the map data is broken into submaps including lane graphs.

FIG. 6 illustrates the route segment of FIG. 5 with the driving lane segments approaching an intersection identified.

FIG. 7A illustrates the intersection in the route of FIG. 5 identifying the driving lanes the AV may interact with when proceeding straight through the intersection.

FIG. 7B illustrates the intersection in the route of FIG. 5 identifying the driving lanes the AV may interact with when turning left through the intersection

FIG. 7C illustrates the intersection in the route of FIG. 5 identifying the driving lanes the AV may interact with when turning right through the intersection

FIG. 8 illustrates how the driving lanes through an intersection would be broken up into driving lane segments when driving straight through the intersection.

FIG. 9 illustrates how the driving lanes through an intersection would be broken up into driving lane segments when turning left through the intersection.

FIG. 10 illustrates the route segment of FIG. 5 with the driving lane segments identified as the AV approaches a merge.

FIG. 11 illustrates the driving lane segments of a two-lane merge.

FIG. 12 illustrates the route segment of FIG. 5 with the driving lane segments approaching an off-ramp identified.

FIG. 13 illustrates the driving lane regions in which the AV may drive when choosing to proceed past the off-ramp of FIG. 12.

FIG. 14 illustrates the driving lane segments when exiting the highway via the off-ramp of FIG. 12.

FIG. 15 illustrates the sample route segment of FIG. 5 broken into its ten driving lane segments.

FIG. 16A illustrates a sample submap coordinate frame for a local region of the map generated by Static Local Map Task.

FIG. 16B illustrates a submap-to-submap transform graph for the example configuration of FIG. 16A.

FIG. 17 illustrates a sample configuration where a local map multiplexer receives a static local map derived from the static map data of an onboard map by a static local map task as well as perceived local maps derived from the extracted lanes by a perceived local map task.

FIGS. 18A-18B together illustrate a sample embodiment of a local map server and multiplexer architecture.

FIGS. 19A-19B together illustrate an alternative embodiment of the embodiment of FIGS. 18A-18B where the map requesting function is broken into separate building and serving functions.

FIGS. 20A-20B together illustrate a further alternative embodiment where the route merging occurs in the local map task stack as opposed to in the vehicle command stack as illustrated in FIGS. 19A-19B.

FIGS. 21A-21B together illustrate another alternative embodiment similar to that of FIGS. 20A-20B except that a large radius prefetcher prefetches a relatively large radius of map data that is processed into lane graphs by the map builder.

FIGS. 22A-22B together illustrate yet another alternative embodiment similar to that of FIGS. 21A-21B except that a map server is provided that generates lane graphs for all or a significant portion of the on-disk map data so that the map data may be readily provided in response to queries.

FIGS. 23A-23B together illustrate yet another alternative embodiment similar to that of FIGS. 21A-21B except that a large radius map generator is provided that generates map data for pre-fetching by the large radius prefetcher.

FIGS. 24A-24B together illustrate yet another alternative embodiment similar to that of FIGS. 22A-22B except that an asynchronous map requester is provided that interfaces with the map server to asynchronously select the map data based on the progress of the vehicle along the route.

FIG. 25 illustrates a sample process flow of the local map server and multiplexer described herein in sample embodiments.

FIG. 26 is a block diagram showing one example of a software architecture for a computing device.

FIG. 27 is a block diagram illustrating a computing device hardware architecture, within which a set or sequence of instructions can be executed to cause a machine to perform examples of any one of the methodologies discussed herein.

### DESCRIPTION

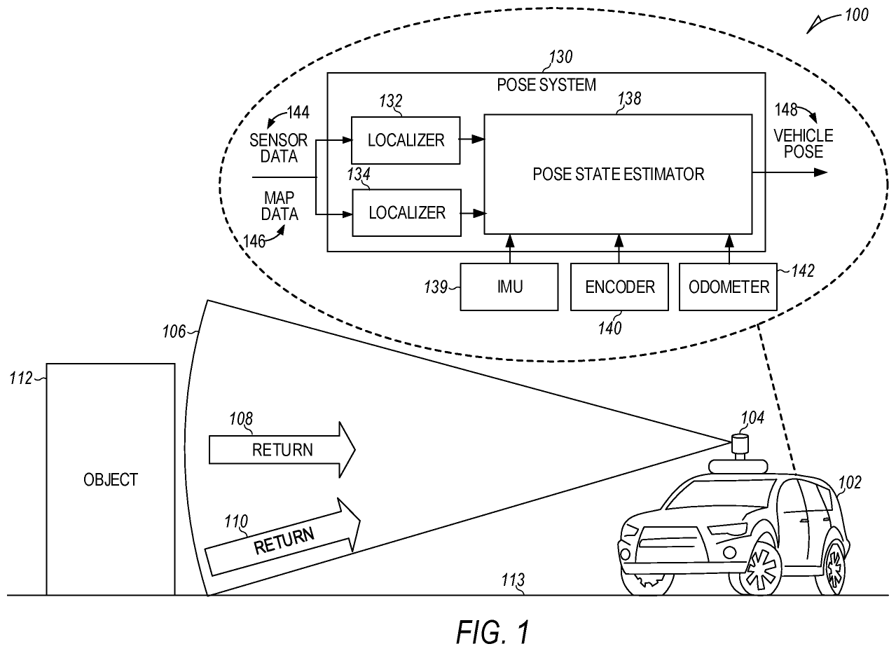

It should be understood at the outset that although an illustrative implementation of one or more embodiments are provided below, the disclosed systems and/or methods described with respect to FIGS. 1-27 may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As described herein, an autonomous vehicle is a vehicle that is capable of sensing its environment and operating some or all of the vehicle's controls based on the sensed environment. An autonomous vehicle includes sensors that capture signals describing the environment surrounding the vehicle. The autonomous vehicle processes the captured sensor signals to comprehend the environment and automatically operates some or all of the vehicle's controls based on the resulting information. In an autonomous or semi-autonomous vehicle, an autonomous vehicle (AV) control system controls one or more of the braking, steering, or throttle of the vehicle. In a fully-autonomous vehicle, the AV control system assumes full control of the vehicle. In a semi-autonomous vehicle, the AV control system assumes a portion of the vehicle control, with a human user (e.g., a vehicle operator) still providing some control input.

The local map server and multiplexer described herein removes the map access from the critical cycle of the autonomy stack of the autonomous vehicle by abstracting the map access function and enabling querying of a map that is constantly updated to reflect map content extrapolated from the pose and/or route of the vehicle. The local map server reads in map data based on the pose and/or route of the vehicle and breaks the map data into map partitions that are stitched together to create a map that is provided to the autonomy stack in response to map queries. In sample embodiments, the “stitched” map includes lane graph data projected out from the current vehicle pose and heading along the current route. The lane graph data encodes nominal paths of motion within lanes. The route is thus an overlay onto the map that whitelists portions of the map that is actionable by the AV. The map data is provided to the autonomy stack as a response message that does not require disk access, thereby avoiding the latency of disk access in the critical path of the autonomy stack. The multiplexer enables the system to substitute perceived data when the pose and route information is unreliable or unavailable and to merge the map data and the perceived data where appropriate.

The local map server and multiplexer described herein introduces a single semantic API that enables all map consuming processes on the vehicle to search a map abstracted from the underlying map schema, as well as to provide a more efficient way to serve map data. The Static Local Map Task is responsible for serving to the autonomy stack “local” sections of the map. Data from the On-Disk Layer of the Lane Graph Map may be provided as a subset of data that is optimized for local map usage by the autonomous vehicle. For modules that require contextual modifications to the map (i.e., nominal paths demonstrative of a right turn assertion,) that role may be subsumed in a static map serving infrastructure or other domain-specific tasks may be relied upon that can take into account the relevant context. For example, the motion planning stack needs to generate feasible, compliant trajectories and thus needs to be able to do things like generate turn assertion nominal paths.

When map relative pose is valid (and hence the vehicle knows where it is in an on-disk map), the vehicle command stack may be responsible for communicating the route as a collection of sequences of map lane IDs along with additional metadata. The pose and route data are converted to lane and boundary data that is put in a message and exposed to the autonomy stack for query. The Static Local Map Task is responsible for taking the lane identifiers and returning the per-driving-lane geometry and metadata (i.e., intersections, speed zones, crosswalks) for both the driving lanes represented by each map ID sequence and the driving lanes that reasonably conflict with that route. The Static Local Map Task creates an abstraction of the local map data as a function of pose and route, pre-caches the map data in “chunks” based on pose and route of the vehicle in a domain independent cache and builds map messages in response to map queries from map consuming processes that may or may not be domain-specific. The multiplexer further provides the ability to insert perceived map data to merge the static map and perceived data and/or to use the perceived map data when the static map data is unreliable or unavailable. The local map server and multiplexer thus provide a context for map caching based on the pose and route of the vehicle and leverage the cached map to pull the map data needed by the respective elements of the autonomy stack and to only expose to the autonomy stack the relevant map data.

In sample embodiments, a system for providing map data to a vehicle includes a static map memory that stores static map data, a map relative pose dependent server that generates submaps from the static map data based on pose and/or route information for the vehicle, sensors that provide environmental data as perception data, an application program interface that generates map requests typically on behalf of an autonomous vehicle stack, and a multiplexer that enables selection of the generated submaps and/or the perception data in response to a map request. In sample embodiments, the multiplexer compares the generated submaps and the perception data in response to a map request and provides the perception data when the generated submaps do not match the perception data. The system thus abstracts the map request and generates and stores in cache maps based on the current pose and/or route for selection rather than relying upon accessing a disk for map data.

In the sample embodiments, the map relative pose dependent server includes at least one processor unit and a machine-readable medium comprising instructions thereon that, when executed by the at least one processor unit, causes the at least one processor unit to perform operations including receiving pose data from a pose state estimator, requesting map data for a current submap including the vehicle based on the pose data, deriving at least one point from received current submap data and requesting all submaps within a predetermined sensor radius of the at least one point, and merging all submap responses together and publishing the merged submaps as a response message to the map request. On the other hand, when route data is received from a vehicle command system, the operations include identifying a sub-region of interest along the route, receiving pose data from a pose state estimator, requesting map data for multiple submaps in a sub-region of interest along the route based on the pose data, deriving at least one geometric point from each received submap data and requesting all submaps within a predetermined sensor radius of the at least one geometric point for each received submap, and merging all submap responses together and publishing the merged submaps as a response message to the map request.

In the sample embodiments, the submaps are also converted to lane graphs and provided in response to the map request. The conversion includes generating a submap-to-submap transform graph. This transform graph supplies transforms from each submap's reference frame to any directly neighboring submap's reference frame. This transform graph can be visited so that all map data is transformed into the reference frame of a single submap. Vehicle localization, which synchronizes a vehicle relative pose with a submap relative pose, can then be used to transform the entirety of the local map data into the vehicle reference frame. This process is used when the vehicle's pose is relative to the origin of a current submap as opposed to a continuous reference frame available at vehicle startup. The origin of the current submap is arbitrary. If the transforms from the current submap to other submaps are known (submap-to-submap transform graph), then the vehicle pose can be used to determine the displacement between the AV's continuous pose and the AV's current submap-relative pose and transforms within the submap-to-submap transform graph may be accumulated to generate a rigid transform from any submap in the graph to the AV's current submap. These processes may be combined to transform map data (which is stored relative to an arbitrary submap) into the AVPs continuous reference frame.

In further sample embodiments, a perceived local map is generated from perception data from the sensors and provided to the multiplexer for selection. The perceived local map may include, for example, a perceived lane graph generated from lanes detected by the sensors. The perceived local map may be provided by the multiplexer in place of the static local map or the static local map and perceived local map may be merged in response to the map request. This provides a novel way to update the static map data to reflect changes to the local environment (e.g., construction).

In sample embodiments, the map relative pose dependent server may include a map requester that requests static map data from the static map memory based on at least one of pose and route information for the vehicle and a map builder that merges the requested static map data into submaps and generates a response message including the merged submaps in response to the map request. These functions may be performed by one element or the elements may be separated within the system.

As discussed herein, the logic, commands, or instructions that implement aspects of the systems and methods described herein may be provided in a computing system including any number of form factors for the computing system such as desktop or notebook personal computers, mobile devices such as tablets, netbooks, and smartphones, client terminals and server-hosted machine instances, and the like. Another embodiment discussed herein includes the incorporation of the techniques discussed herein into other forms, including into other forms of programmed logic, hardware configurations, or specialized components or modules, including an apparatus with respective means to perform the functions of such techniques. The respective algorithms used to implement the functions of such techniques may include a sequence of some or all of the electronic operations described above, or other aspects depicted in the accompanying drawings and detailed description. Corresponding methods and computer-readable media including instructions for implementing the methods described herein also constitute sample embodiments.

### Terminology

Contextual Map Data—Map data specific to the context of “driving.” This includes information describing the road-network including, but not limited to, lane boundaries, lane connectivity, control mechanisms and nominal paths of motion through the road network.

Partition—A spatial-regioning of the map. The partitions may be purely spatial, or they may be derived from contextual map data such that consumers of the partitions can make contextual assumptions. Submaps are an example of a partition that is derived from contextual map data.

Local Map—A map composed of multiple “relevant” partitions. The relevance of the maps is determined by the state of the AV as determined by, for example, pose and route. For example, the partitions composing the local map may be submaps. In sample embodiments, the local map includes the data that can be found in the lane graph layer of the MLT's on-disk map, and only in local proximity to the vehicle, based either on a perception radius, or in proximity to the route being followed. The local map is derived from two different data sources including static map data typically stored on disk and perceived map data derived from sensor data.

Map builder—An application responsible for generating the local map data representation and returning a subset of this map data on request. For example, the map builder may implement the Static Local Map Task API described in detail below. The map builder uses pose and/or route to pre-cache a large radius of map data.

Map requester (prefetcher)—A module that may be implemented as a single process (e.g., XIS task) within the distributed system whose responsibility is to use AV state (pose, route, etc.) to fetch map data from disk that is relevant to downstream consumers of the map data. Downstream consumers will subscribe to the “latest” version of the map data published by the map requester. A static local map task (SLMT) is the pre-fetcher responsible for serving contextual map data to perception, prediction and motion planning systems of the vehicle autonomy system.

Asynchronous Data Requester—A module (generally implemented as an XIS task) used with a remote procedure call (RPC)-based implementation of the map builder and whose responsibility is to manage the lifetime of asynchronous data requests to the map builder by respective consumers of the map data.

Local Map Route—Translation of the route from a vehicle command format that uses MLP lane identifiers to a format generalized for the local map. A subset of data from the vehicle-command route plan required by the perception, prediction, and motion planning systems of the vehicle autonomy system is exposed for query.

Driving Lane Segment—This is an abstract entity that describes a portion of a driving lane. A driving lane segment is represented as a sequence of MLP lane identifiers, as well as with richer representations, such as lane geometry. Unique Driving lane segments are guaranteed to contain a unique subset of all MLP lanes. Driving lane segments are each linked by a successor-predecessor relationship. Branching point segments are cut whenever there are multiple predecessors or successors. A successor of driving lane segment “A” is defined as the set of driving lane segments whose first underlying MLP lane succeeds A's last underlying MLP lane. A predecessor of driving lane segment A is defined as the set of driving lane segments whose last underlying MLP lane precedes A's first underlying MLP lane.

Driving Lane Region—This region represents a portion of a driving lane segment or driving lane and is encoded as offsets along the nominal path and lane boundaries of a driving lane or driving lane segment. This region is useful for encoding spatial lane information that changes at a smaller granularity than driving lane segments (i.e., speed zones, lane change regions, etc.). The encoded data also may include distance traveled, heading, accelerometer reading, and the like.

Nudge Lane—A driving lane which is not the lowest cost driving lane in the AV's immediate vicinity. The nudge lane is intended for use by the AV for traversing around obstacles or navigating towards a lower cost driving lane. The nudge driving lane may change over the course of a route.

Super Nudge Lane—This is a nudge driving lane that is directed in the direction opposite of the AV's intended direction of travel.

Local Route—A local route is a collection of driving lanes in which the AV may travel. It includes nudge and super nudge driving lanes. The driving lanes provided in the route do not need to meet the non-overlap requirements of driving lane segments.

Diversion Point—This is a point along the route at which transitively neighboring driving lanes diverge (no longer have a neighbor relation). If a single driving lane diverges into multiple non-neighboring driving lanes, then this criterion is met. Non-neighboring successor lanes do not necessarily represent diversion points if the successor lanes quickly regain their neighbor relationship.

Branching Point—A point along the route where a driving lane segment has multiple successors or predecessors.

Submaps—A type of road-network partition where intersections and multiple lane successors and predecessors are contained within a single partition.

### Autonomous Vehicle

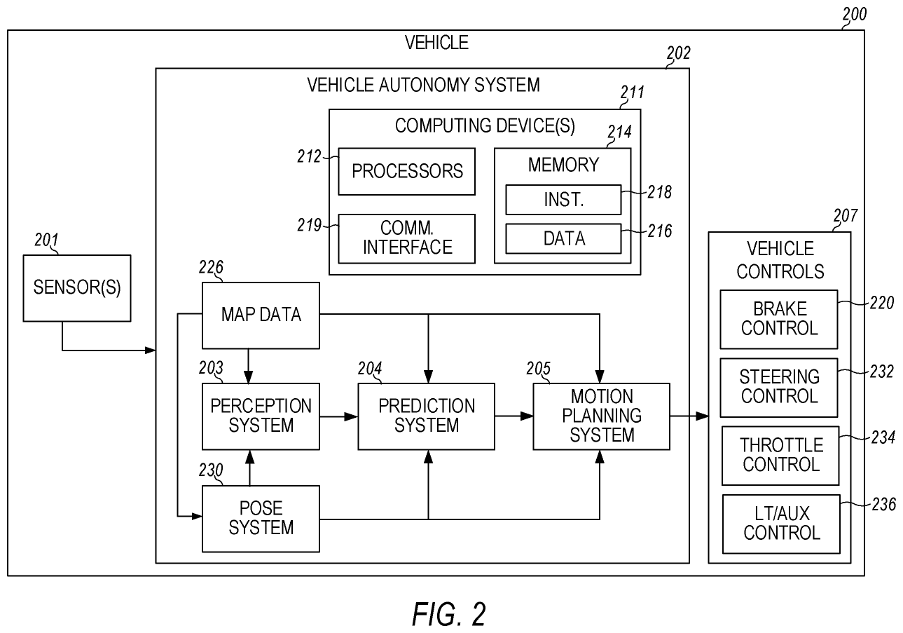

FIG. 1 is a diagram showing one example of an environment 100 including a vehicle 102 having a pose system 130. The vehicle 102, in some examples, is a self-driving vehicle (SDV) or autonomous vehicle (AV) comprising a vehicle autonomy system (FIG. 2) for operating the vehicle without human intervention. In some examples, the vehicle also, in addition to or instead of a full autonomous mode, includes a semi-autonomous mode in which a human user is responsible for some or all control of the vehicle.

The vehicle 102 comprises one or more remote detection sensors 104 that receive return signals 108, 110 from the environment 100. Return signals 108, 110 may be reflected from objects, such as the object 112 and/or ground 113. The remote detection sensors 104 may include one or more active sensors, such as a LIDAR or RADAR, that emit electromagnetic radiation 106 in the form of light or radio waves to generate return signals 108, 110. In some examples, the remote detection sensors 104 include a passive sensor, such as a set of stereoscopic cameras, that receive reflected ambient light or other radiation. The remote detection sensors 104 are shown on top of the vehicle 102. Remote detection sensors 104 may be positioned at any suitable position on the vehicle 102, however, including, for example, on a bumper, behind the windshield, etc.

The pose system 130 receives remote sensor data 144 and reference map data 146 and generates vehicle poses 148. One or more localizers 132, 134 utilize the remote sensor data 144 and the reference map data 146 to generate pose estimates that are provided to the pose state estimator 138. The pose state estimator 138 also receives motion sensor data from one or more motion sensors such as, for example, an inertial measurement unit (IMU) 139, one or more encoders, such as encoder 140, and/or an odometer 142. Motion sensor data may be used to supplement pose estimates received from the one or more localizers 132, 134. Although two localizers 132, 134 are shown in FIG. 1, more or fewer localizers may be used.

FIG. 2 is a block diagram showing one example of a vehicle 200 according to example aspects of the present disclosure. The vehicle 200 can be, for example, an autonomous or semi-autonomous vehicle such as vehicle 102 illustrated in FIG. 1. The vehicle 200 includes one or more sensors 201, a vehicle autonomy system 202, and one or more vehicle controls 207. The vehicle autonomy system 202 can be engaged to control the vehicle 200 or to assist in controlling the vehicle 200. The vehicle autonomy system 202, sometimes referred to as an Autonomous Vehicle (AV) stack, receives sensor data from the one or more sensors 201, attempts to comprehend the environment surrounding the vehicle 200 by performing various processing techniques on data collected by the sensors 201, and generates an appropriate motion path through the environment. The vehicle autonomy system 202 can control the one or more vehicle controls 207 to operate the vehicle 200 according to the motion path.

The vehicle autonomy system 202 includes a perception system 203, a prediction system 204, a motion planning system 205, and a pose system 230 that cooperate to perceive the surrounding environment of the vehicle 200 and determine a motion plan for controlling the motion of the vehicle 200 accordingly. The pose system 230 may be arranged to operate as described herein.

Various portions of the autonomous vehicle system 202 receive sensor data from the one or more sensors 201. For example, the sensors 201 may include remote detection sensors as well as other sensors, such as an inertial measurement unit (IMU), one or more encoders, one or more odometers, etc. The sensor data can include information that describes the location of objects within the surrounding environment of the vehicle 200, information that describes the motion of the vehicle, etc.

The sensors 201 may also include one or more remote detection sensors or sensor systems, such as a LIDAR, a RADAR, one or more cameras, etc. As one example, a LIDAR system of the one or more sensors 201 generates sensor data (e.g., remote sensor data) that includes the location (e.g., in three-dimensional space relative to the LIDAR system) of a number of points that correspond to objects that have reflected a ranging laser. For example, the LIDAR system can measure distances by measuring the Time of Flight (TOF) that it takes a short laser pulse to travel from the sensor to an object and back, calculating the distance from the known speed of light.

As another example, for a RADAR system of the one or more sensors 201 generate sensor data (e.g., remote sensor data) that includes the location (e.g., in three-dimensional space relative to the RADAR system) of a number of points that correspond to objects that have reflected ranging radio waves. For example, radio waves e,g., pulsed or continuous) transmitted by the RADAR system can reflect off an object and return to a receiver of the RADAR system, giving information about the object's location and speed. Thus, a RADAR system can provide useful information about the current speed of an object.

As yet another example, one or more cameras of the one or more sensors 201 may generate sensor data (e,g., remote sensor data) including still or moving images. Various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in image or images captured by the one or more cameras. Other sensor systems can identify the location of points that correspond to objects as well.

As another example, the one or more sensors 201 can include a positioning system that can determine a current position of the vehicle 200. The positioning system can be any device or circuitry for analyzing the position of the vehicle 200. For example, the positioning system can determine a position by using one or more of inertial sensors, a satellite positioning system such as a Global Positioning System (GPS), based on IP address, by using triangulation and/or proximity to network access points or other network components (e,g., cellular towers, Wi-Fi access points, etc.) and/or other suitable techniques. The position of the vehicle 200 can be used by various systems of the vehicle autonomy system 202.

Thus, the one or more sensors 201 can be used to collect sensor data that includes information that describes the location (e,g., in three-dimensional space relative to the vehicle 200) of points that correspond to objects within the surrounding environment of the vehicle 200. In some implementations, the sensors 201 can be located at various different locations on the vehicle 200. As an example, in sonic implementations, one or more cameras and/or UDAR sensors can be located in a pod or other structure that is mounted on a roof of the vehicle 200 while one or more RADAR sensors can be located in or behind the front and/or rear bumper(s) or body panel(s) of the vehicle 200. As another example, camera(s) can be located at the front or rear bumper(s) of the vehicle 200 as well. Other locations can be used as well.

The pose system 230 receives some or all of the sensor data from sensors 201 and generates vehicle poses for the vehicle 200. A vehicle pose describes the position and attitude of the vehicle. The position of the vehicle 200 is a point in a three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a pitch about a first horizontal axis and a roll about a second horizontal axis. In some examples, the pose system 230 generates vehicle poses periodically (e.g., every second, every half second, etc.) The pose system 230 appends time stamps to vehicle poses, where the time stamp for a pose indicates the point in time that is described by the pose. The pose system 230 generates vehicle poses by comparing sensor data to reference map data 226 describing the surrounding environment of the vehicle 200. The pose system 230, in some examples, is arranged similar to the pose system 130 of FIG. 1. For example, the pose system 130 may comprise one or more localizers and a pose state estimator.

The perception system 203 detects objects in the surrounding environment of the vehicle 200 based on sensor data, reference map data 226 and/or vehicle poses provided by the pose system 230. Reference map data 226, for example, may provide detailed information about the surrounding environment of the vehicle 200, for example, relating remote sensor data to vehicle position and/or attitude. The reference map data 226 can further provide information regarding the identity and location of different roadways, segments of roadways, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway); traffic control data (e.g., the location and instructions of signage, traffic lights, or other traffic control devices); and/or any other reference data that provides information that assists the vehicle autonomy system 202 in comprehending and perceiving its surrounding environment and its relationship thereto. A roadway is a place where the vehicle can drive and may include, for example, a road, a street, a highway, a lane, a parking lot, a driveway, etc. The perception system 203 utilizes vehicle poses provided by the pose system 230 to place the vehicle 200 at a particular location and/or attitude, for example, based on reference data, and thereby predict which objects should be in the surrounding environment of the vehicle 200.

In some examples, the perception system 203 determines state data for one or more of the objects in the surrounding environment of the vehicle 200. State data may describe a current state of an object (also referred to as features of the object). The state data for each object describes, for example, an estimate of the object's current location (also referred to as position); current speed (also referred to as velocity); current acceleration; current heading; current orientation; size/shape/footprint (e.g., as represented by a bounding shape such as a bounding polygon or polyhedron); type/class (e.g., vehicle versus pedestrian versus bicycle versus other); yaw rate; distance from the vehicle 200; minimum path to interaction with the vehicle 200; minimum time duration to interaction with the vehicle 200; and/or other state information.

In some implementations, the perception system 203 can determine state data for each object over a number of iterations. In particular, the perception system 203 can update the state data for each object at each iteration. Thus, the perception system 203 can detect and track objects, such as vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 can generate prediction data associated with one or more of the objects detected by the perception system 203. In some examples, the prediction system 204 generates prediction data describing each of the respective objects detected by the perspective system 204.

Prediction data for an object can be indicative of one or more predicted future locations of the object. For example, the prediction system 204 may predict where the object will be located within the next 5 seconds, 20seconds, 200seconds, etc. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the pose system 230 and/or reference data 226.

In some examples, the prediction system 204 uses state data indicative of an object type or classification to predict a trajectory for the object. As an example, the prediction system 204 can use state data provided by the perception system 203 to determine that particular object (e.g., an object classified as a vehicle) approaching an intersection and maneuvering into a left-turn lane intends to turn left. In such a situation, the prediction system 204 can predict a trajectory (e.g., path) corresponding to a left-turn for the vehicle such that the vehicle turns left at the intersection. Similarly, the prediction system 204 can determine predicted trajectories for other objects, such as bicycles, pedestrians, parked vehicles, etc. The prediction system 204 can provide the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 determines a motion plan for the vehicle 200 based at least in part on the predicted trajectories associated with the objects within the surrounding environment of the vehicle, the state data for the objects provided by the perception system 203, vehicle poses provided by the pose system 230, and/or reference map data 226. Stated differently, given information about the current locations of objects and/or predicted trajectories of objects within the surrounding environment of the vehicle 20, the motion planning system 205 can determine a motion plan for the vehicle 200 that best navigates the vehicle 200 relative to the objects at such locations and their predicted trajectories on acceptable roadways.

In some implementations, the motion planning system 205 can evaluate one or more cost functions and/or one or more reward functions for each of one or more candidate motion plans for the vehicle 200. For example, the cost function(s) can describe a cost (e.g., over time) of adhering to a particular candidate motion plan while the reward function(s) can describe a reward for adhering to the particular candidate motion plan. For example, the reward can be of opposite sign to the cost.

Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate pathway. The motion planning system 205 can select or determine a motion plan for the vehicle 200 based at least in part on the cost function(s) and the reward function(s). For example, the motion plan that minimizes the total cost can be selected or otherwise determined. The motion plan can be, for example, a path along which the vehicle 200 will travel in one or more forthcoming time periods. In some implementations, the motion planning system 205 can be configured to iteratively update the motion plan for the vehicle 200 as new sensor data is obtained from one or more sensors 201. For example, as new sensor data is obtained from one or more sensors 201, the sensor data can be analyzed by the perception system 203, the prediction system 204, and the motion planning system 205 to determine the motion plan.

Each of the perception system 203, the prediction system 204, the motion planning system 205, and the pose system 230, can be included in or otherwise a part of a vehicle autonomy system configured to determine a motion plan based at least in part on data obtained from one or more sensors 201. For example, data obtained by one or more sensors 201 can be analyzed by each of the perception system 203, the prediction system 204, and the motion planning system 205 in a consecutive fashion in order to develop the motion plan. While FIG. 2 depicts elements suitable for use in a vehicle autonomy system according to example aspects of the present disclosure, one of ordinary skill in the art will recognize that other vehicle autonomy systems can be configured to determine a motion plan for an autonomous vehicle based on sensor data.

The motion planning system 205 can provide the motion plan to one or more vehicle control systems 207 to execute the motion plan. For example, the one or more vehicle control systems 207 can include throttle systems, brake systems, steering systems, and other control systems, each of which can include various vehicle controls (e.g., actuators or other devices that control gas flow, steering, braking, etc.) to control the motion of the vehicle. The various control systems 207 can include one or more controllers, control devices, motors, and/or processors.

The vehicle control systems 207 can include a brake control module 220 that is configured to receive a braking command from the vehicle autonomy system 202 (e.g., from the motion planning system 205), and in response, brake the vehicle 200. In some examples, the brake control module 220 includes a primary system and a secondary system. The primary system may receive braking commands and, in response, brake the vehicle 200. The secondary system may be configured to determine a failure of the primary system to brake the vehicle 200 in response to receiving the braking command.

A steering control system 232 is configured to receive a steering command from the vehicle autonomy system 202 (e.g., from the motion planning system 205) and, in response, provide a steering input to steer the vehicle 200. A throttle control system 234 is configured to receive a throttle command from the vehicle autonomy system (e.g., from the motion planning system 205) and, in response, provide a throttle input to control the engine or other propulsion system of the vehicle 200. A lighting/auxiliary control module 236 may receive a lighting or auxiliary command. In response, the lighting/auxiliary control module 236 may control a lighting and/or auxiliary system of the vehicle 200. Controlling a lighting system may include, for example, turning on, turning off, or otherwise modulating headlines, parking lights, running lights, etc. Controlling an auxiliary system may include, for example, modulating windshield wipers, a defroster, etc.

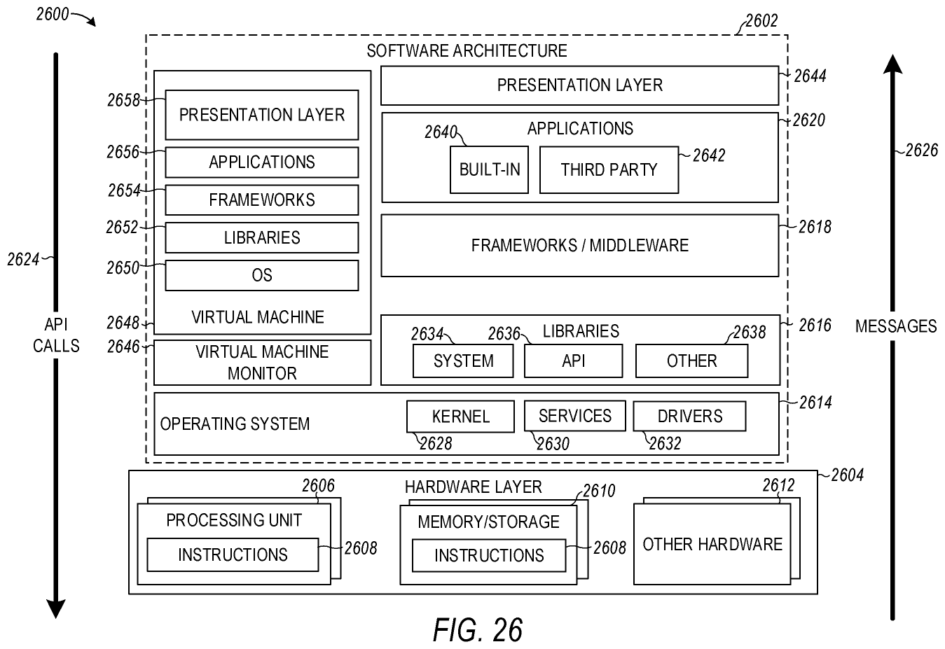

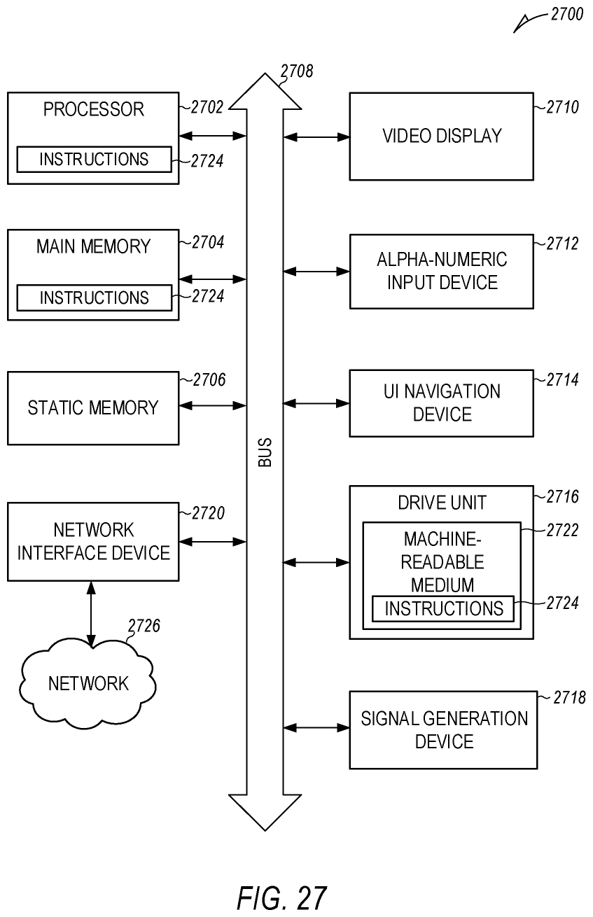

The vehicle autonomy system 202 includes one or more computing devices, such as the computing device 211, that may implement all or parts of the perception system 203, the prediction system 204, the motion planning system 205 and/or the pose system 230. The example computing device 211 can include one or more processors 212 and one or more memory devices (collectively referred to as memory) 214. The one or more processors 212 can be any suitable processing device (e.g., a processor core, a microprocessor, an Application Specific integrated Circuit (ASIC), a Field Programmable Gate Array (FPGA), a microcontroller, etc.) and can be one processor or a plurality of processors that are operatively connected. The memory 214 can include one or more non-transitory computer-readable storage mediums, such as Random-Access Memory (RAM), Read Only Memory (ROM), Electrically Erasable Programmable Read Only Memory (EEPROM), Erasable Programmable Read Only Memory (EPROM), flash memory devices, magnetic disks, etc., and combinations thereof. The memory 214 can store data 216 and instructions 218 which can be executed by the processor 212 to cause the vehicle autonomy system 202 to perform operations. The one or more computing devices 211 can also include a communication interface 219, which can allow the one or more computing devices 211 to communicate with other components of the vehicle 200 or external computing systems, such as via one or more wired or wireless networks. Additional descriptions of hardware and software configurations for computing devices, such as the computing device(s) 211 are provided below with respect to FIG. 26 and FIG. 27.

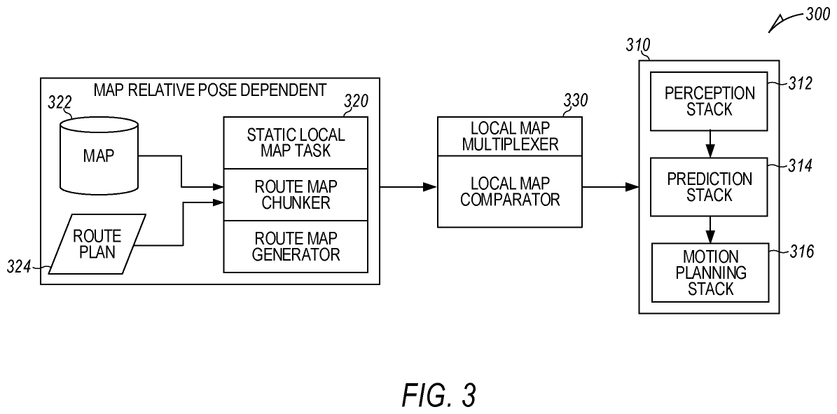

FIG. 3 illustrates a map relative pose dependent architecture 300 for providing local map data to the AV stack 310 including perception stack 312, prediction stack 314, and motion planning stack 316 in sample embodiments. As illustrated in FIG. 3, a static local map task (SLMT) 320 reads in static map data from static map database 322 and a route plan 324 generated by the AV stack 310 in sample embodiments. The SLMT 320 generates local map data representations at runtime as a function of the MLP lane graph representation provided as input data in the route plan. The SLMT 320 also generates a contextual determination of relevant map data by using pose and route as inputs to guarantee a sensor radius lateral and to the rear of the AV with a predetermined amount of along-the-route map data. The SLMT 320 thus uses the route plan data to generate chunks of map data from the static map data from static map database 322 and generates route maps relevant to the received route plan 324. The local map multiplexer 330 receives the static map data and the perceived map data independently and either forwards the static map data or perceived map data as is or merges the two together and then provides the resulting map to the AV stack 310. Unfortunately, the SLMT 320 is generally quite complicated because it must account for a latent data generation process in a deterministic environment.

The system and method described herein modify the map relative pose dependent architecture 300 of FIG. 3 to further provide an XIS remote procedure call mechanism capable of interfacing with multiple consumers of map data. A map RPC server is further implemented that is capable of serving per-submap datums. This architecture is not for serving spatial map data (localization prior, etc.) but is instead used to serve contextual map data. In sample embodiments, the contextual map data is extended to all onboard data requirements for all users of map data, whether or not such users have identical spatial access patterns. For example, such consumers include the operator control system (OCS), which uses map data centered around the AV to enable a safety driver to visualize what data is available to the autonomy system. Other consumers include the AV stack 310, which uses a designated amount of map data along the route and a sensor radius lateral and to the rear of the vehicle. Another consumer of map data is a lane associator that generates a ranking of lanes against which the SDV or AV has been localized. For example, the lane associator operates on a radius of 30 meters surrounding the SDV or AV.

The SLMT 320 in FIG. 3 accesses map data via a Route Map Interface (RMI). The SLMT 320 relies on the RMI to efficiently cache required map data. However, this presents two issues. First, caching logic and data source abstraction is injected via a C++ runtime polymorphism, which is undesirable. Second, the RNI's cache is per-process, which disallows leveraging like access patterns across the whole system. Also, the SLMT 320 potentially makes it more difficult to experiment with new map data sources and caching strategies.

In the embodiment of FIG. 3, the SLMT 320 is responsible to figure out identifiers for map data and to include those identifiers in map requests. The map builder then stitches the submaps together that are associated with these identifiers. Thus, the map builder's job is to persist and to cache the map data and it is the job of SLMT 320 to figure out what to request. However, the design requirements of FIG. 3 lack separation of responsibilities. The SLMT 320 is also not very good at persisting already generated data. Ideally, the SLMT 320 would not be responsible for the caching of fetched data.

In the embodiment of FIG. 3, the static local map may be injected directly into the prediction stack 314 and the motion planning stack 316. Motion planning stack 316 cannot accept new routes if the local map was not built with awareness of the new route. The prediction stack 314 listens to the local map and transforms it into the AV's continuous reference frame on every cycle. In both cases, the map access uses valid map relative pose.

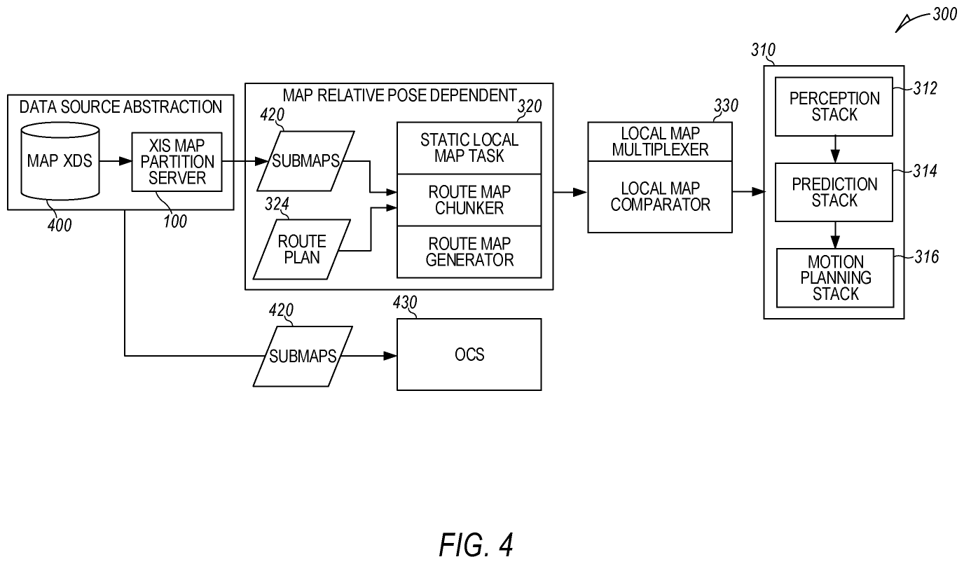

The system and method described below addresses these and other needs in the art by providing an onboard system and method whose sole tasks are to generate the local map data representation and to cache the results across map consumer requests. For example, as shown in FIG. 4, the system of FIG. 3 is modified to include a data source abstraction including the static map data 400 and a map partition server 410 that provides submaps 420 to the SLMT 320 and OCS 430 as a response to a map request. As will be explained in more detail below, a pre-fetcher task interacts with the map partition server 410 by requesting data via an identifier-based or spatial-indexing request mechanism such as:
local_map request(const std::vector<guid>&partition_identifiers);
local_map request(const std::vector<mlp::gps_point>&points, distance_m radius);

The map partition server 410 provides the functionality of the map builder defined above and is responsible for intelligently caching the local map data representation that is associated with each partition or submap, as well as with other partitions or submaps in the same spatial region of the map. Pose is used to determine the relevance of the partitions (submaps) to onboard consumers of the map data. The pose need not necessarily be high quality pose as used by the autonomy stack as, in this case, the pose is used to extract map subregions. Using pose, all partition data (submaps) within a radius that approximately represents double the Service Level Agreement (SLA) requirements with any of the onboard map data consumers is cached. This approach assumes that onboard access patterns are self-centered to the map data consumer and that the amount of data required by any map data consumer is light enough such that storing approximately twice that data is feasible on the vehicle. Those skilled in the art will appreciate that if egocentric access patterns cannot be assumed that the cache may be thrashed as users randomly access data across the entire map. Those skilled in the art will further appreciate that if the amount of data required is not light that user requests may be blocked as their region of interest within the map expands. In sample embodiments of the system and method described herein, only the first request will be blocked as all future requests would already be buffered into RAM.

Alternatively, since each local map state is approximately 30 KB, the entire map of a city could be pre-fetched. For example, Phoenix may be mapped using only 70,000 submaps, which means that the entire map of Phoenix may be pre-fetched with only ˜2.1 GB of RAM. As long as the data representation is generated offline, generation of each map datum would still need to be scheduled but already generated data would not have to be discarded.

An XIS-compatible onboard remote procedure call (RPC) mechanism is extended to multiple map consumers by either adding identifier information to each request and filtering responses based on this identifier or adding per-task scoping to the response channels generated by the RPC framework. However, the former approach requires each map consumer to deserialize all requests while the latter approach has the benefit of only deserializing map datums intended specifically for the requester. Those skilled in the art will appreciate that the request mechanism need not support deterministic playback, as long as the pre-fetcher tasks have the deterministic state needed to inform the required blocking RPC request. Also, in sample embodiments, the RPC server will be treated as a process independent of the deterministic task pipeline.

The operation of the embodiment of FIG. 4 may be better understood by using the SLMT 320 in an example. The data flow for the map partition server 410 generally will be as follows. First, the SLMT 320 receives pose from the localizer as described above with respect to FIG. 2. The SLMT 320 then makes a request to the map partition server 410 for a single partition's map data. This partition is representative of the pose-associated submap. The map partition server 410 then receives the request from the SLMT 320. Because the map partition server 410 uses pose to pre-cache map data, the requested partition is most likely in cache. If not, the map partition server 410 blocks while generating the map data for just that one partition. The SLMT 320 then receives a response with map data for just its current submap. Using the spatial request mechanism outlined above, the SLMT 320 then derives a point (or points) from the map data and requests all partitions (submaps) within sensor radius of that point. The map partition server 410 next receives a spatially-indexed data request. Using spatial indexing provided by the RMI, the map partition server 410 queries for all submaps in the given radius around the vehicle location. The map partition server 410 then checks its cache for all desired submaps and blocks while generating submaps that are not currently cached. The SLMT 320 next receives a response to its spatially-indexed data request. This includes a duplicate of the partition (submap) it received in its first request. The SLMT 320 then merges these responses together and publishes them downstream to the AV stack 310, which expects map data via a subscription mechanism. Finally, at some point in the future, the SLMT 320 receives a route from the vehicle command system. The SLMT 320 then identifies a sub-region of interest along the route needed to meet its 300 m along route SLA. The above steps are then repeated with the difference being that multiple partitions are requested in the first request, and geometric points derived from all partitions are sent in the second, spatially-indexed request.

As noted above, the local map data need not be generated in the map partition server 410 but may be generated offboard the vehicle. The local map data also may be loaded from disk. Both implementations may be made injectable via the XIS configuration system.

Also, in sample embodiments, the system will only serve a single map datum representative of all data in the lane graph. It may be desirable in alternate embodiments to allow users to request partial data representations. As an example, consider a lane graph described only as adjacency state and distances. The map partition server 410 may be able to buffer much more of this data (considering its lighter footprint), which allows onboard map consumers to more efficiently walk the lane-graph and determine map elements for which a richer data representation is required.

It will be appreciated that the embodiment of FIG. 4 including local map multiplexer 330 enables multiple configurations. For example, the motion planning stack 316 may subscribe to a local map. When map data is perceived data, the perceived data may be integrated into the motion planning stack first, prior to integrating the local map representing the static data. The local map data will be converted to stay lane routes, which are motion planning representations of lane data. The stay lane routes are specifically for planning since they predetermine branches based off the route (i.e., straight versus right turn) and are thus able to represent a single lane through an intersection, where the base map really has two successors.

On the other hand, when the local map data is static, the RMI will he used to access the on-disk map directly. Alternatively, the motion planning stack 316 may subscribe to a local map and use the local map data when data was generated by perceived or static stacks. In other words, the local map multiplexer 330 is fully-capable of multiplexing between a perception generated and a static map. Such configurations permit route changes to be processed without updates from the local map ecosystem. Also, local map data may be transmitted in different reference frames exposed in the client. This is required if the validity of the data is to persist over time and if the map generation is to be moved outside of the routing critical path. In such a case, the client applies different transform logic depending on the reference frame of the underlying data. On the other hand, the static map may generate data in many map-relative reference frames. In addition, the perceived map data may be generated in a continuous reference frame and output as a full map rather than just necessary inputs to the localizer. The system of FIG. 4 also allows injection of lane geometry when static data shows significant divergence from observed data (i.e., construction zones.)

### Static Local Map Task

As noted above, the Static Local Map Task (SLAT) 320 includes a route map chunker and a route map generator that breaks the map into servable “chunks” that are served in accordance with the AV's pose. In operation, the SLMT 320 assures that potentially conflicting driving lanes will be expanded and extracted to the extent necessary for guaranteeing that each driving lane is available for a constant duration of compliant driving as that driving lane approaches the AV's route. If that range exceeds sensor range, the sensor range will be extracted. The driving lanes in the AV's route also will be extracted such that a constant number of seconds of driving lane data is available to the motion planning stack at any point in time. This data may exceed sensor range. However, if the route is invalid, a local map with sensor range radius around the vehicle will be generated and published. Users will be able to query for whether or not the local map is route-aware.

The SLMT 320 operates on a route where each driving lane is represented as an MLP lane identifier sequence. In sample embodiments, the SLMT 320 generates all of the driving lane segments that the AV and any lane-bound obstacle around the AV may interact with. The SLMT 320 also generates an overlay that restricts where the AV may drive. The cost-to-goal is basically used as a simple proxy for which driving lane segments should he preferred by the AV. For example, the cost-to-goal on a per-route basis enables the autonomy stack to choose which route is preferred as the AV approaches a diversion point. The following example explains how many route-based local maps would need to be generated for the motion planning stack to be able to make “diversion point decisions” such as a left turn versus a right turn. Thus, the following description is specific to a route-aware implementation of the local map stacks.

In sample embodiments, the SLMT 320 generate submaps that require or guarantee the following:

1. Each route is representative of a single path to goal. In other words, each route only considers one path through any diversion point along that route.

2. For diversion points, successor MLP lanes that are neighbors of each other should be treated as a single branch. This implies that an n-way intersection can always be traversed with no more and no less than (n-1) routes.

3. Routes should include MLP lane identifier sequences representing nudge and super nudge driving lanes.

4. Routes should include metadata describing the points along each driving lane where the AV may lane change.

5. Each driving lane should be associated with a cost-to-goal at the end of the driving lane. If the driving lane reaches the goal, the cost should be zero. The motion planning stack 316 uses cost-to-goal to determine which driving lanes it should prefer, but the motion planning stack 316 does not care about the cost-to-goal on a per-MLP-lane basis.

6. The SLMT 320 will use the data in each route structure for limiting the area of the map exposed in the local map structure. The AV will be prohibited from planning in driving lane regions not associated with the MLP lane identifier sequences underlying the route. This establishes a clear synchronization point in the online system for propagating online updates to where the AV may or may not drive.

7. The SLMT 320 uses the cm-disk map 322 for exploration of conflicting MLP lanes.

8. Lane changes do not act as multipliers on the number of routes in the scene as lane changes are not route diversion points.

9. Routes do not need to be kinematically feasible. This issue may be solved by exposing a severely pruned, but locally complete, set of route options. For example, a route and associated map would be provided for each of the N exits from an intersection. To limit the amount of data, the data would be pruned longitudinally along the route at intervals (e.g., 300 m).

10. In order to limit the combinatorial explosion of route options, the AV may be limited to considering only the nearest diversion point, at which point it will explore the rest of the route only in the lowest cost direction.

11. Unique driving lane segments may be generated at branching points along the map. When generating driving lane segments, the SLMT 320 may apply the following rules:

It is acceptable to concatenate an MLP lane to its predecessor driving lane segment if there are not multiple MLP lanes succeeding the driving lane segment

It is acceptable to concatenate an MLP lane to its predecessor driving lane segment if that MLP lane does not have multiple predecessors.

It is noted that the route does not affect how driving lane segments are generated. It simply provides an overlay onto the independently generated driving lane segments.

### Example Route

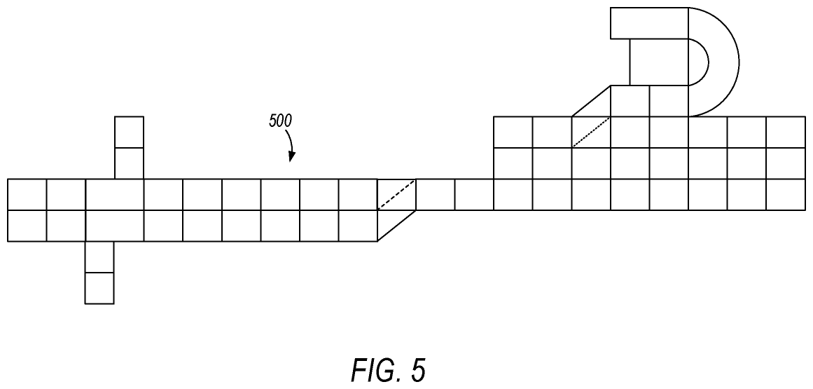

To illustrate how the SLMT 210 may generate driving lane segments for a route for serving in response to map queries in sample embodiments, the route segment 500 illustrated in FIG. 5 will be broken down below for an AV that requires a route from the leftmost MLP lanes to the rightmost MLP lanes. FIG. 5 shows a simple lane graph with the following characteristics (from right to left): (1) a 3-way intersection; (2) a merge; and (3) a 4-lane road with a “slide lane” into an offramp. It will be appreciated that the route segment 500 of FIG. 5 is not representative of any single route, but of many routes. The following sections will demonstrate how the AV can determine which route to follow as it progresses towards the goal and what route segments are served by the SLMT 320 along the route.

In the following description, emboldened lines are used to demarcate driving lane segments. To distinguish between the multiple routes options that should be presented at each diversion point, each unique route will be represented by different markings. The driving lane regions exposed in the AV's route overlay will use a darker shading to communicate that the AV may drive in the underlying MLP lanes of the owning driving lane segment.

### Route Diversion Point One: Intersection Approach

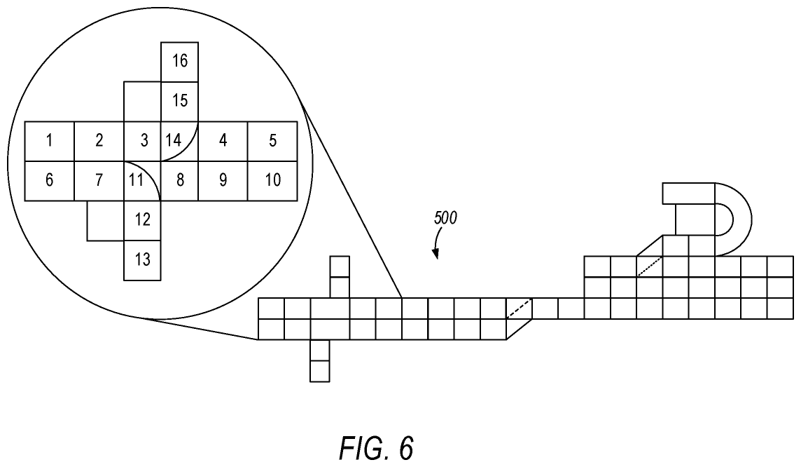

FIG. 6 illustrates the route segment of FIG. 5 with the MLP lanes in the 3-way intersection identified. FIG. 6 simply annotates the individual “MLP lanes” in the 3-way intersection with numbers for explaining the driving lane segments. In FIG. 6, the AV approaches an intersection from either MLP lane 1 or 6. The localized MLP lane is unimportant for route generation as long as the localized MLP lane is a transitive lateral neighbor of an MLP lane with which the AV is reasonably associated. All MLP and driving lanes in this example proceed in the AV's direction. MLP lane 14 represents the left turn MLP lane through the intersection. MLP lane 11 represents the right turn MLP lane through the intersection. MLP lanes 3 and 8 represent the straight MLP lanes proceeding through the intersection.

FIG. 6 explains the usage of N local routes. However, in the example of FIG. 6, only the left, right and straight route options would be explored as the AV approached the intersection since only the first diversion point is being explored. (The slide lane along the four-lane road represents the second diversion point.) This means that SLMT 320 would explore at most three potential routes at this point in the route. In each diagram, the bolded outlines of the MLP lanes represent separate sequences of successor lanes, which are defined conceptually as driving lanes.

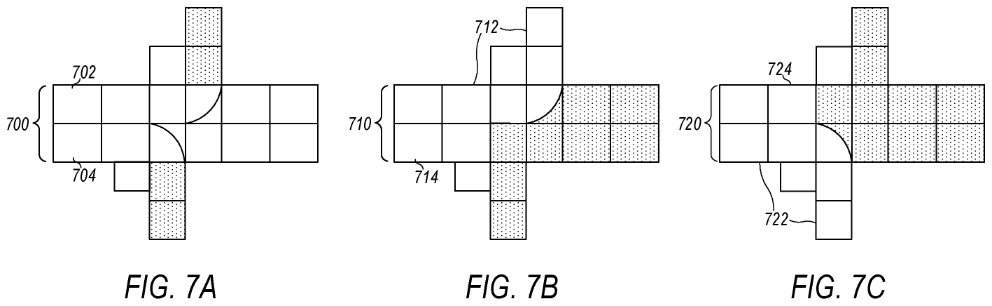

For example, FIG. 7 shows three examples of the concatenation of multiple driving lane segments related via predecessor-successor relationships. In the example of FIG. 7A, the route represents the driving lanes 700 the AV may interact with when proceeding straight through the intersection. If the left driving lane 702 is lower cost-to-goal than the right driving lane 704, then the MLP lane identifier sequence {6, 7, 8, 9, 10} represents a nudge driving lane. If the right driving lane 704 is lower cost-to-goal than the left driving lane 702, then the MLP lane identifier sequence {1, 2, 3, 4, 5} represents a nudge driving lane. The route in FIG. 7B represents the driving lanes 710 the AV may interact with when turning left through the intersection. If the AV chooses to turn left, the left turn driving lane 712 is the lower cost-to-goal. This means that the MLP lane identifier sequence {6, 7} 714 is expanded as the nudge driving lane. The route in FIG. 7C represents the driving lanes 720 the AV may interact with when turning right through the intersection. If the AV chooses to turn right, the right turn driving lane 722 is the lower cost-to-goal. This means that the MLP lane identifier sequence {1, 2} 724 is expanded as the nudge driving lane.

FIGS. 7A-C thus provide a good example of rules two and nine, namely, that when approaching an n-way intersection, the AV should always be considering at most (n-1) routes. These routes do not need to be aware of the AV's specific location in the lanes approaching the intersection. In other words, the routes do not have to be kinematically feasible.

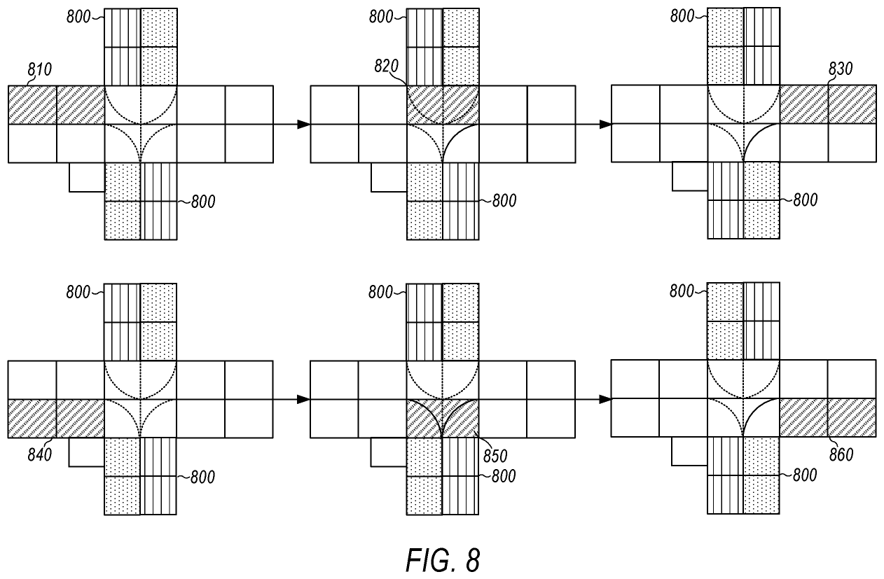

FIG. 8 demonstrates how the SLMT 320 would break up the route into driving lane segments. Driving lane segments that move in the opposing direction relative to the AV, are represented at 800. Representing the route straight through the intersection would require six driving lane segments 810, 820, 830, 840, 850, and 860 since each driving lane segment entering the intersection has multiple successors and each driving lane segment exiting the intersection has multiple predecessors. The unique driving lane segments for the first driving lane in this route would contain the MLP lane identifier sequences (top row): {1, 2}, {3} and {4,5}. The second driving lane would contain MLP lane identifier sequences {6, 7}, {8} and {9, 10}.

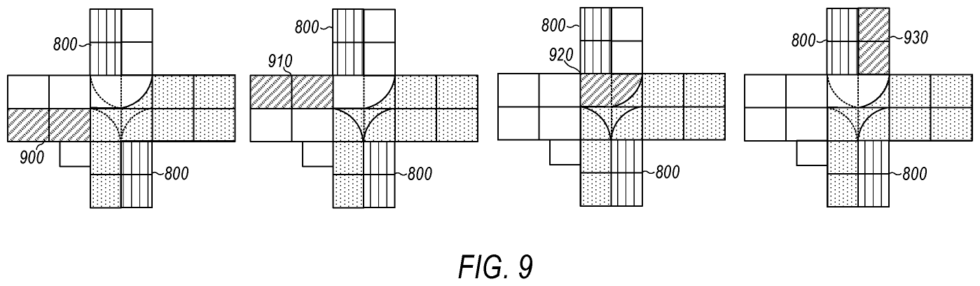

For the route turning left through the intersection, on the other hand, only four route-associated driving lane segments 900, 910, 920, and 930 are needed (FIG. 9), The unique driving lane segments are composed of the MLP lane identifier sequences (in order): {1, 2}, {6, 7}, {14} and {15, 16}. Similar results would be obtained when turning right through the intersection.

### Two Lane Merge Approach (Not A Diversion Point)

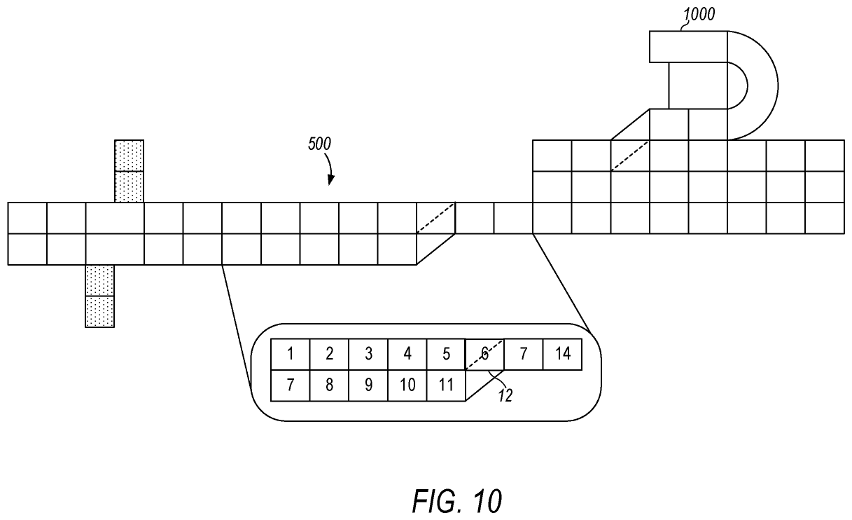

FIG. 10 illustrates the route segment of FIG. 5 with the MLP lanes approaching a merge identified. In FIG. 10, the AV approaches a merge from either MLP lane 1 or 7. This section of the route has only one immediate route option since there is no diversion point present. A merge has multiple predecessors, which does not qualify as a diversion point, but does require that it be broken into multiple lane segments in order to avoid non-unique driving lane segments. As the AV approaches the merge, the nearest diversion point is now the “U”-shaped highway off-ramp 1000 that is well down the road. At this point, the AV will start considering new routes emanating from the off-ramp (as per rule ten).

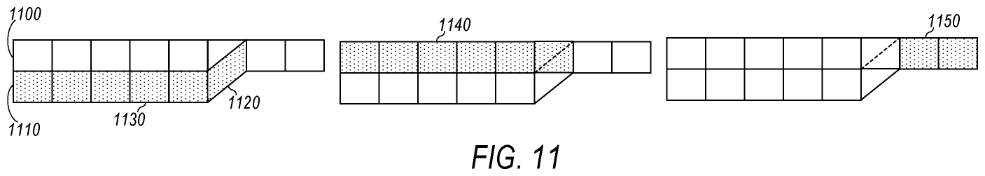

As illustrated in FIG. 11, there are two driving lanes 1100 and 1110, which eventually overlap beginning at the merge point 1120. To represent the merging of driving lanes, the lanes are broken into three MLP lane identifier sequences 1130, 1140, and 1150 each of which has no overlap with any other sequence in this set. For clarification, these driving lanes segments are composed of MLP lane identifier sequences {1, 2, 3, 4, 5, 6}, {7, 8, 9, 10, 11, 12} and {13, 14} as illustrated in FIG. 11.

### Route Diversion Point Two: Highway Off-Ramp Approach

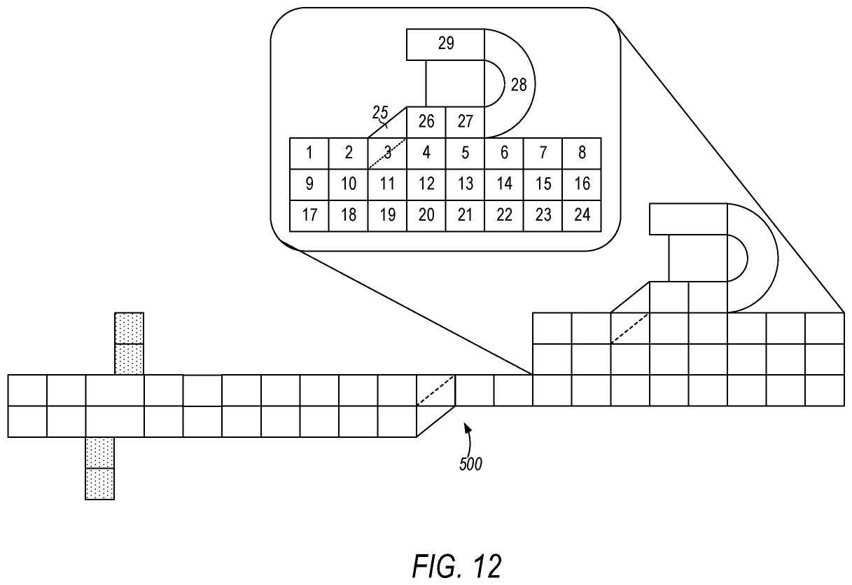

FIG. 12 illustrates the route segment of FIG. 5 with the MLP lanes approaching an off-ramp identified. In FIG. 12, the AV continues approaching an off-ramp from either of MLP lanes 1, 9 or 17. A split MLP lane to the offramp succeeds MLP lane 2 and splits into MLP lanes 3 and 25. The AV has two options in this scenario—to continue past the exit on the highway, or to exit the highway via the off-ramp.

In order to allow lane changes into the off-ramp after having proceeded past MLP lane 2 or a neighbor of MLP lane 2, MLP lane 11 should contain a lane change region into MLP lane 3, and MLP lane 3 should contain a lane change region into MLP lane 25. Without this neighbor relationship, it would be impossible for the AV to lane change into the off-ramp without having first proceeded past the entirety of MLP lane 3. Depending on the dimensions of MLP lanes 4, 5 and their neighbors, this may be kinematically infeasible. To address this issue, lane change regions exist across driving lane segments in the regions where their MLP lanes overlap. It is the role of downstream map consumers to deal with any issues that may arise from lane change regions between driving lane segments with physical overlap.

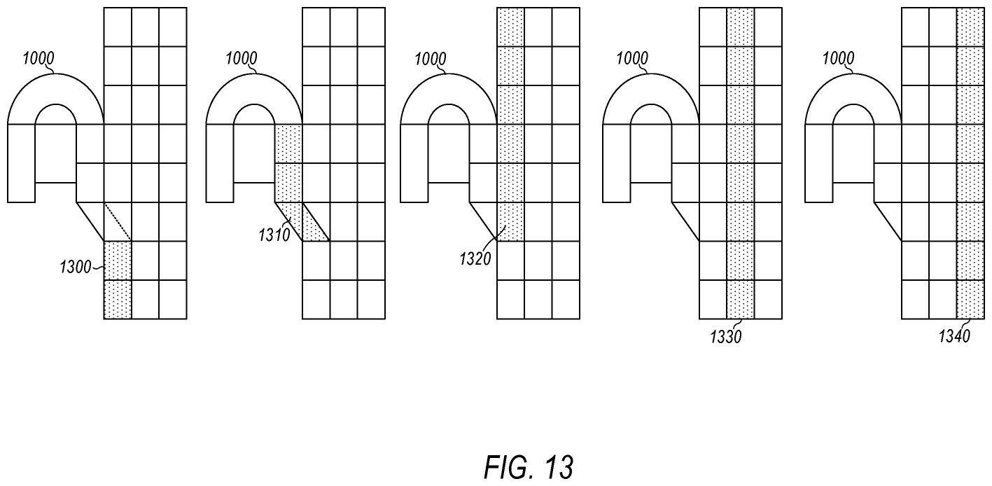

FIG. 13 demonstrates the five driving lane regions 1300, 1310, 1320, 1330, and 1340 in which the AV may drive when choosing to proceed past the off-ramp 1000. The split MLP lane results in three driving lane segments 1300, 1310, and 1320. The driving lane region 1310 splitting towards the off-ramp is expanded up until the neighboring driving lane segment are no longer accessible. This driving lane region 1310 can be used as a nudge lane. Note that the region in the route is independent of the driving lane segments in the local map.

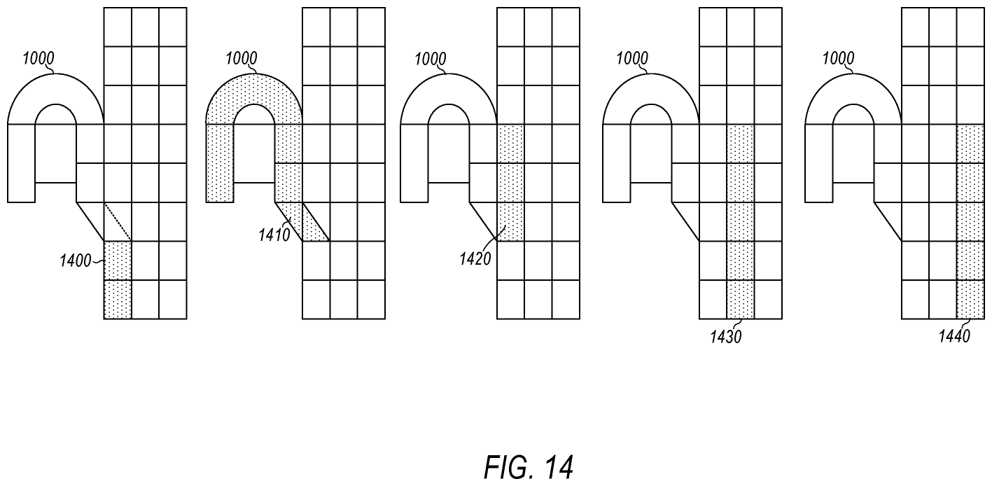

FIG. 14 demonstrates the second, and final, option—exiting the highway via the off-ramp 1000. Like the previous example shown in FIG. 13, the split MLP lane results in three driving lane segments 1400, 1410, and 1420. Unlike the previous example, the non-exit ramp driving lanes 1430 and 1440 only have driving lane regions that are accessible for as long as they neighbor the off-ramp. The regions 1430 and 1440 now act as nudge driving lanes for following the route.

It is noted that the split lane is not a diversion point, since MLP lanes 25 and 3 are still neighbors. It is not until MLP lane 27 that non-neighboring MLP lanes are approached. MLP lane 27 and its transitive neighbors, MLP lanes 5, 13 and 21, represent a diversion point. It is best to think of this as MLP lane 28 does not neighbor any of MLP lanes 6, 14, or 22 although MLP lane 28's predecessor, MLP lane 27, was a transitive neighbor of MLP lanes 5, 13, and 21.

It is also noted that while these two route options communicate different driving lane regions in which the AV can drive, they contain the same exact set of driving lane segments. Since the route does not influence the makeup of the driving lane segments, this allows the SLMT 320 to maintain persistent identification of driving lane segments across cycles, even when the route changes.

### The Big Picture: End-to-End Route

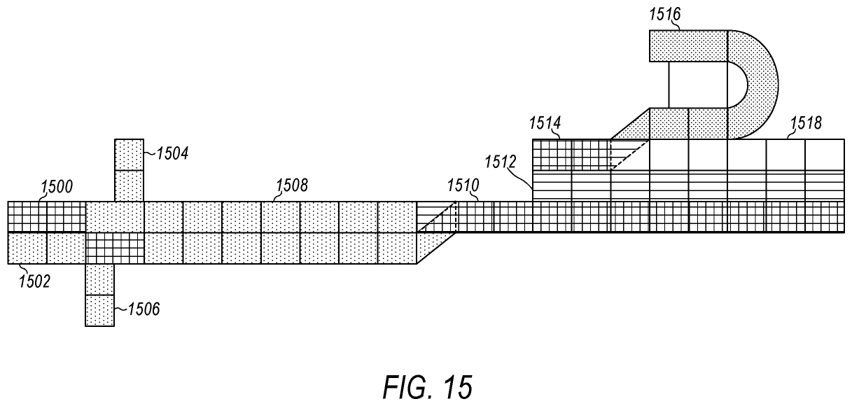

Using FIGS. 6-14, it is now possible to consider how many driving lane segments it takes to cover the whole route of FIG. 5 end-to-end. Using the rules mentioned above, the route of FIG. 5 can be represented with ten driving lane segments. FIG. 15 demonstrates the extents of each of these ten driving lane segments 1500-1518. Driving lane segments 1504 and 1506 represent driving lane segments that are not present in the AV's route overlay. The dashed lines are used to represent overlap lanes at merge points and splits. It is noted that the nudge driving lane is fluid. A driving lane that may have been the lowest cost driving lane at some point along the route may require an eventual lane change out of itself and into an even lower cost driving lane. At that point in the route, the first driving lane into which the lane changed is now the nudge driving lane.

### Local Map Structure and API

The SLMT 320 is responsible for turning the MLP-focused route representation described above with respect to FIGS. 5-15 into a map representation describing the 3D geometry and map attributes associated with each driving lane segment. The top-level of the generated map is also responsible for describing the driving-lane-independent data in the scene. The serializable local map structure describes this data in an cm-disk format. It is generated out of cycle relative to the rest of the perception, prediction and planning pipeline, and can be queried for sub-portions of its data. Autonomy modules may query the latest local map that they have received. It is the responsibility of SLMT 320 to guarantee that this structure is representative of the data needed by all autonomy modules at any point in time. This structure gives map consumers access to the following information:

Road Polygons: Includes perimeter polygon and internal “hole” polygons needed to describe islands, medians, and other static, mappable obstacles.

Parking Spot Polygons: Parking polygons are exposed for each driving lane segment.

Driving Lane Geometry—The nominal path and lane boundary data describing each driving lane segments. All data will be stored in three-dimensions. Distance and curvature will be cached for efficient querying.

In addition to the above information, the local map stores information as annotations on top of longitudinal slices of the driving lane segments. These are called driving lane regions. The following is a list of information available as a driving lane region:

Lane Change Regions—Contains a trace into another driving lane segment along with the slice of that segment with which this lane change region is associated.

Speed Zones—Contains the speed at which compliant vehicles should drive.

Speed Bumps—Contains the polygon describing the speed bump.

Crosswalks—Contains the polygons describing the crosswalk and also contains control information. Can be joined with traffic signal predictions for querying whether the crosswalk has right of way as a function of time.

Turn Regions—Describes whether a region along a driving lane segment is representative of a turn. Can span multiple driving lane segments.

Lane Markers—Describes the lane markers bordering the associated driving lane segment. Left and right lane boundary markers are represented as unique slices.

Intersections—Describes the right of way status and control method of the intersections a defined by the motion planning stack 316. Allows cross lane information, and crosswalk information to be extracted for entities that are associated with specific intersections.

Cross Lanes—Describes lane crossing the associated lane segment and is polygon-convertible. Can be queried for priority of cross lane over another lane at a particular point in time.

Each driving lane segment associated with the local map will include the above information. The local map is guaranteed to contain the driving lane segments needed to fulfill high-level requests.

The underlying map geometry for each driving lane segment may be stored in a common map-relative based coordinate frame. With this representation, each sequence of successive driving lane segments can he concatenated to form a full driving lane in a common coordinate frame without requiring knowledge of the individual submap-to-submap transforms.

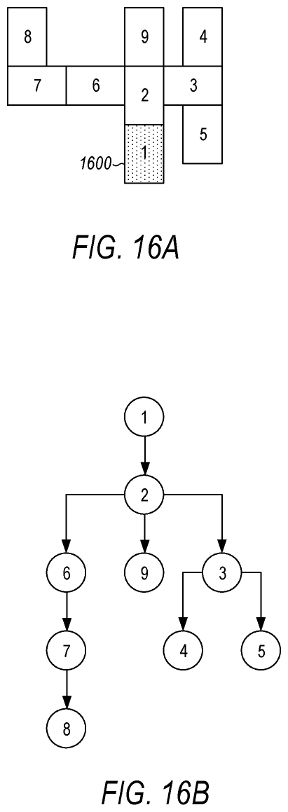

FIG. 16A illustrates a sample submap layout for a local region of the map generated by SLMT 320 as described above. In this example, the submap 1600 indicates the coordinate frame the geometry for the static local map was extracted in by the SLMT 320. FIG. 16B illustrates a submap-to-submap transform graph for the example configuration of FIG. 16A. In FIG. 16B, each edge represents a transform from the parent submap to the child submap.

To interface with the perception stack 312 and prediction stack 314, this representation needs to be transformed into the continuous coordinate frame. This is done by querying the underlying submap-to-submap transform graph (e.g., FIG. 16B) which was used to generate the current Local Map. Using the current vehicle pose, which contains transformations from the vehicle frame to the current submap and continuous frames, the appropriate submap-to-submap transform may be queried to move from the reference submap to the current submap.

For the example above, if the current vehicle pose was in submap 6 of FIG. 16A and the local map data were stored in submap 1, the following series of transformations would be required to move the Local Map into the continuous coordinate frame:
T_{ContinuousVehicle}*(T_{Submap6Vehicle})⁻¹*(T_{Submap6Submap2})⁻¹*(T_{Submap2Submap1})⁻¹
   In these transformations, T_{ContinuousVehicle} and T_{Submap6Vehicle} were both queried from the current vehicle pose, and the other two transforms were queried from the submap-to-submap transform graph of FIG. 16B. This homogeneous transformation can be applied to all the underlying geometry in the Local Map to transform the current Local Map into the continuous coordinate frame.

It is important to note that each driving lane segment may be composed of multiple submaps. In the example of FIG. 16A, submap 6 and submap 7 would most likely be part of a single driving lane segment. The same transformation logic described above can be used to transform the underlying geometry in the driving lane segments into the continuous frame.

Geometry provided by the perceived local map task will already be in the continuous frame. The mechanism which identifies the root submap in the Local Map will be used to indicate no submap-to-continuous transform needs to be applied.

### Perceived Local Map Server

As noted above with respect to FIG. 3, a local map multiplexer 330 may be used to enable selection between the local map generated by the SLMT 320 as described above or a local perceived map. Switching to a perceived local map is advantageous, for example, to enable the AV to continue driving when the static map is unavailable or invalid or when the world does not match the static map as a result of construction, and the like. The perceived data may be processed by a lane detection algorithm to generate lane graph data that is extracted by the lane extraction algorithm and delivered to the autonomy stack 310 when appropriate. For example, the lane extraction algorithm may receive a starting point and a distance transform of the lane boundaries and find the optimal trajectory that minimizes the costs. The lane extraction algorithm may also implement topological lane analysis to determine when and where a new lane appears or changes to enable the lanes to be tracked correctly. For example, the lane extraction algorithm may be modified to track changes in the number of lanes, lane merges (e.g., on-ramp), and lane splits (e.g., off-ramp). Such changes may be identified by applying coarse lane extraction on the distance transform image by peak detection and line segment clustering and then comparing and finding unmatched lane boundaries between a topical lane analysis and existing lane optimizers. The lane optimizers may be created or updated for merges and splits.

In sample embodiments, a perceived local map task processes the extracted lane chunks to create a local map message that is published to the autonomy stack 310. The published information also may include information such as lane geometry, speed zone, lane change region, and route plan.

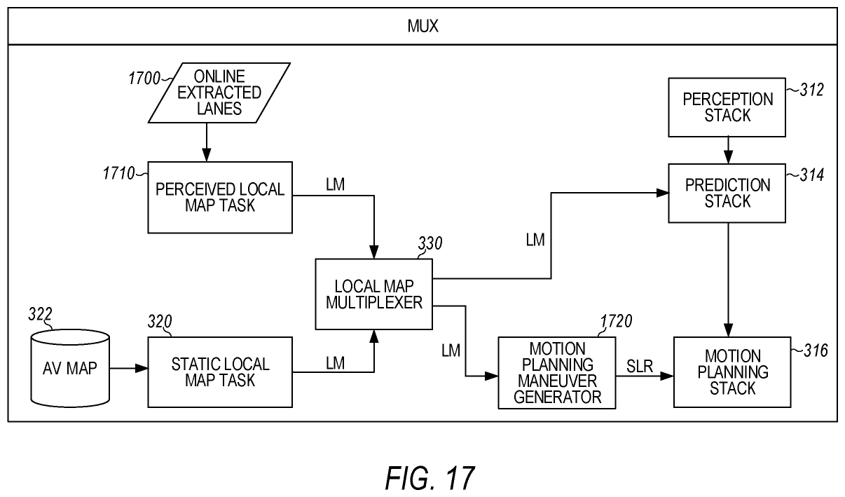

FIG. 17 shows a sample configuration where the local map multiplexer 330 receives the static local map derived from the static map data from onboard map 322 by the SLMT 320 as described above. As illustrated in FIG. 17, the local map multiplexer 330 may also provide perceived local maps derived from the extracted lanes 1700 by the perceived local map task (PLMT) 1710. The local map multiplexer 330 thus enables selection of either the local map from the SLMT 320 or PLMT 1710 based upon whether the local map data is from the SLMT 320 and PLM 1710 differ from each other. For example, if differences are detected, the local map multiplexer 330 may supply the perceived map data under the assumption that the static map is incorrect due to construction, and the like. The selected local map is provided to the prediction stack 314 and may also be provided to the motion planning stack 316 via a motion planning maneuver generator 1720 that may use the identified lanes as constraints. In each case, the map may be provided as a message responsive to a map query received from the autonomous stack 310. Once the SLA is verified to be valid for the static map data, the multiplexer may switch back to the static map data from the perceived map data.

Those skilled in the art will appreciate that the ability to switch to sensor inputs and the perception stack is particularly desired for safety purposes as the static map is unable to respond to changes in road conditions such as an obstacle, road hazard, construction zone, etc The multiplexer 330 enables switching to remedy differences in what is perceived versus what is stored in the static map. Merging the static and perceived map data potentially provides the requesting client API with updated map data that will enable the vehicle to use hybrid routing to reroute as appropriate without having to disable the autonomy stack. This is particularly desirable as routing is generally not available on a perceived map.

### Map Server Embodiments

A map relative pose dependent server configuration including the SLMT 320 described above will now be illustrated in several configurations. In each embodiment, the static map and perceived map are implemented as described herein and the map relative pose dependent server is queried for map data. The local map multiplexer 330 enables seamless switching between the static map or the perceived map without requiring disk access, thereby reducing latency. In sample embodiments, the perceived map and static map are compared to identify discrepancies. The perceived map may be sent instead of the static map when differences are detected. The perceived map and the static map may be combined into a merged map as appropriate.

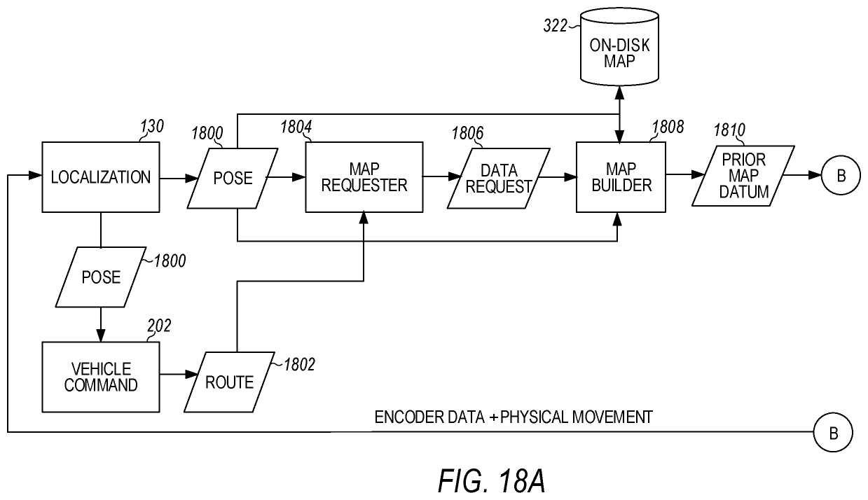

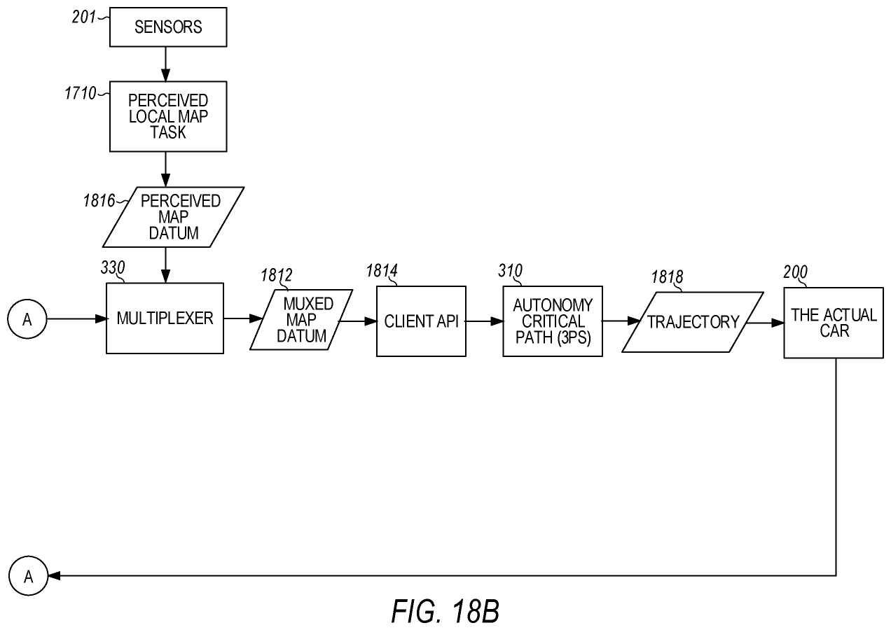

FIGS. 18A-18B together illustrate a sample embodiment of a local map server and multiplexer configuration. In this configuration, the autonomous or semi-autonomous vehicle includes localization circuitry such as the pose system 130 described above that generates the vehicle pose 1800 used by the vehicle command system (e.g., AV system) 202 to generate a route 1801 In the sample embodiments, the pose 1800 and the route 1802 are provided to map requester 1804. Map requester 1804 uses the pose 1800 and/or the route 1802 to generate a map data request 1806 for chunks of map data from the on-disk map 322. For example, the “chunks” of map data pulled from the on-disk map 322 may he map data that is within a predetermined radius (e.g., 2 km) of the current position of the vehicle 200. Alternatively, the map requester 1804 may be route aware and determine where the vehicle is located along its route by finding the closest point on the route to locate the vehicle in a sequence of lanes and then update the radius of route data to generate a request for map data that takes into account the position of the vehicle in the lanes along the route. As illustrated in FIGS. 18A-18B, the map data request is provided to the map builder 1808 which includes the Static Local Map Task API 320 described in detail above, which functions to fetch the map data from the on-disk map 322. Based on the map data request 1806 from the map requester 1804, to pre-cache the fetched map data on top of map data for road chunks based on the pose and/or route of the vehicle, and to piece together the road chunks to create a single lane graph that may be queried by the AV stack 310.

In response to a map query to the map builder 1808, a prior map datum 1810 including map data pulled from the lane graph created by the map builder 1808 and formed into a response message is provided to the multiplexer 330. The prior map datum 1810 may be provided directly to the map requesting process as muxed map datum 1812 via client API 1814. On the other hand, if the prior map datum 1810 is deemed to be unreliable for any reason (e.g., the pose and/or route data is unreliable, the static map data is incomplete, and/or the static map data does not match the perceived data as in the case of a construction zone), the multiplexer 330 may instead provide perceived map datum 1816 to the map requesting process via client API 1814. As described above with respect to FIG. 17, the perceived map datum 1816 is generated by the perceived local map task 1710 based on extracted lane data calculated from sensor data provided by sensors 201. The perceived map datum 1816 and the prior map datum 1810 may be compared by the multiplexer 330 to determine if the prior map datum 1810 is reliable. The perceived map datum 1816 and the prior map datum 1810 may also be combined into muxed map datum 1812 for providing responsive map data to the requesting process of the AV stack 310 via the client API 1814. The requested map data is then used by the requesting process of the AV stack 310 to generate trajectory data 1818 and vehicle command data for the vehicle 200.

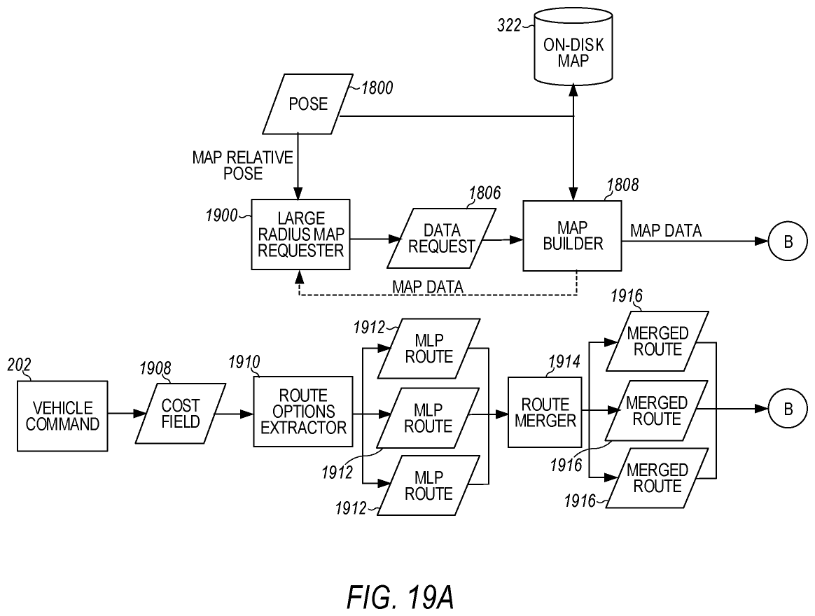

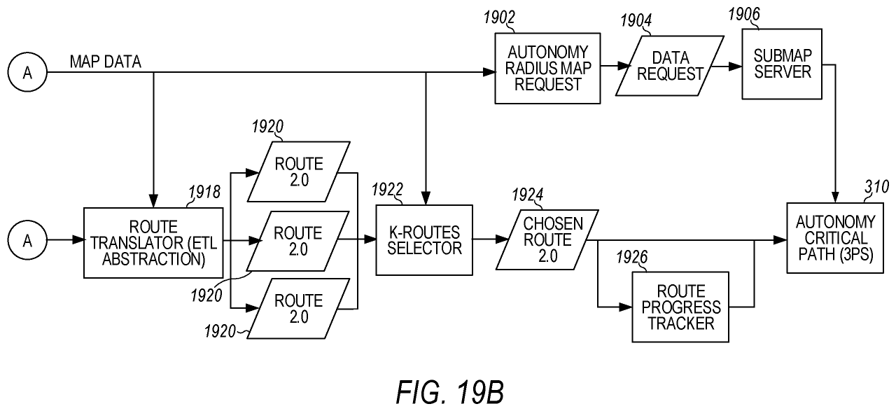

FIGS. 19-24 illustrate alternative embodiments to the embodiment of FIG. 18.

FIGS. 19A-19B together illustrate an alternative embodiment in the map requesting function is broken into map build and map retrieve functions. As illustrated, a large radius map requester 1900 requests a large radius map centered around the vehicle 200. The requested map data is converted into lane graphs by the map builder 1808 as described above. An asynchronous feedback loop is provided that includes: (1) large radius map requester 1900 makes a pose based request; (2) the map builder 1808 generates data for request from (1); (3) the autonomy radius map requester 1902 makes another request for a radius smaller than that in (1); and (4) the map builder 1808 processes the request from (3). This pattern of having multiple radii is something that can be extended to as many radii as needed. In order to determine how far the AV has traveled from the point of a request, map relative locations are used since pose drift is continuous. This means that a transform graph is needed and the only way to get a transform graph is through the bigger blob of map data. To get this data, the large radius map requester 1900 listens to its own response (asynchronously) and the autonomy radius map requester 1902 listens to the large radius response as well.

On the output side of the map builder 1808, an autonomy radius map requester 1902 listens to the map data output by the map builder 1808 to allow its transforms inside the map to determine when to re-request the map data. A map data request 1904 is sent to a submap server 1906, which is the portion of the map builder 1808 that handles requests. In this embodiment, the submap server 1906 handles the map requests separately from the map building function and is thus shown as a separate block. The submaps are provided to the autonomy stack 310 in response to a map request via the multiplexer 330 in the same manner as described above with respect to the embodiment of 18A-18B.

The embodiment of FIGS. 19A-19B further illustrate how the lane graph data generated by the map builder 1808 may be used by the vehicle command 202 to modify the vehicle route for a pose-only local map server. The route is a collection of local map elements that is converted into a set of route options as a collection of elements as used herein. In particular, the autonomy stack receives two messages: 1) the local map (no route association); and 2) a set of route options described as a collection of elements in (1). The vehicle command stack 202 receives a route request (goal point) and pose and generates its route representation. The pose is generated by the localization stack as a function of sensor inputs and changes as the vehicle drives. As illustrated, the vehicle command stack 202 generates a cost field 1908 for each route option that is extracted by route options extractor 1910 to generate possible routes 1912 that are merged by route merger 1914 to generate possible merged routes 1916. The map data output by the map builder 1808 is then used by a route translator 1918 to take the MLP lane described routes and to turn them into driving lane segment described routes. A route selector 1922 of the motion planning stack 316 selects a route 1924 using the map data from the map builder 1808. The chosen route 1924 is provided to the autonomy stack 310 and the vehicle's progress along its route is updated by route progress tracker 1926.

In sample embodiments, route merging is used in mapping systems that do not have a global coordinate frame in the map implementation. Instead, local reference frames with transforms for moving between them are used, and the system must select a path through the map for which transforms are to be applied. If where the AV is going and where it is coming from are known, error along that path can be minimized so that map elements do not appear to shift from one second to the next as may be caused by choosing different transform paths. In order to get a consistent transform, the route is used to inform where the AV is coming from and where it is going. This means that route history is tacked onto the beginning of the route. This may be done in the AV stack or in the routing stack, which identifies the N possible local routes for selection by the motion planner. Generally speaking, these two stacks are different because of legacy map usage. The N selected routes are then represented in terms of local map elements.

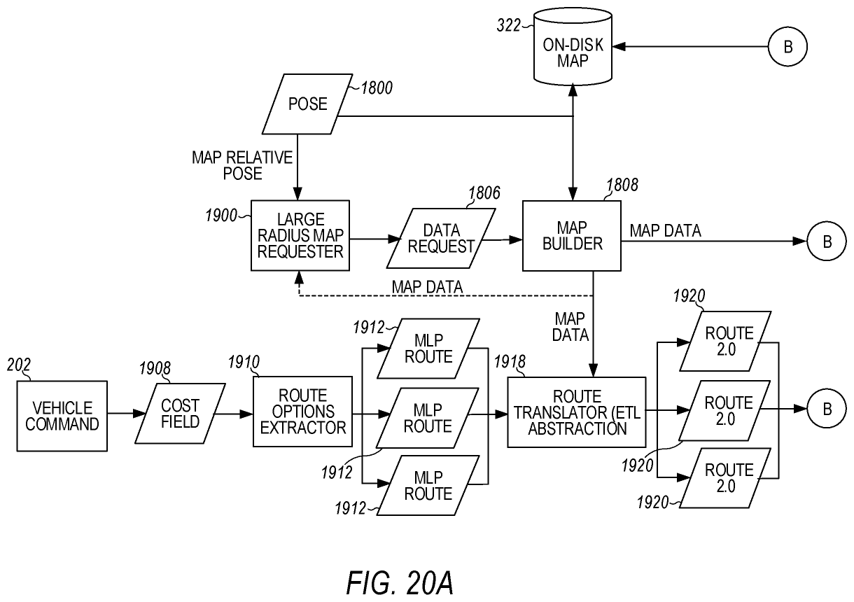

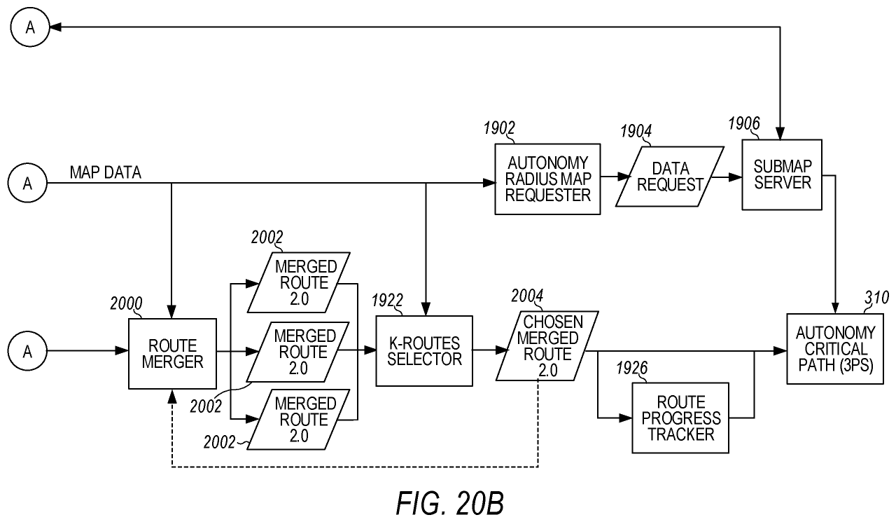

FIGS. 20A-20B together illustrate a further alternative embodiment where the route merging happens in the local map task stack as opposed to in the vehicle command stack as illustrated in FIGS. 19A-19B. FIGS. 20A-20B operate the same as FIGS. 19A-19B except the routes provided by the vehicle command stack 202 have no route history. The route history is added to enable the AV to know where it is coming from, which transforms to be applied that minimize jumps in map data along the AV's historical path (so lanes stay in the same place behind the AV rather than jumping some distance.) In the embodiment of FIGS. 20A-20B, the map builder 1808 generates a large radius map that is used by the route translator 1918 to take MLP lane described routes and turns them into driving lane segments prior to route merger 2000, which provides proposed merged routes 2002 to the route selector 1922 of the motion planning stack 316 for selection of a merged route 2004 that is provided to the autonomy stack 310. The vehicle's progress along its route is updated by route progress tracker 1926. Also, in this embodiment, the submap server 1906 may access the on-disk map 322 directly to serve map data to the autonomy stack 310 via the multiplexer 330 as desired.

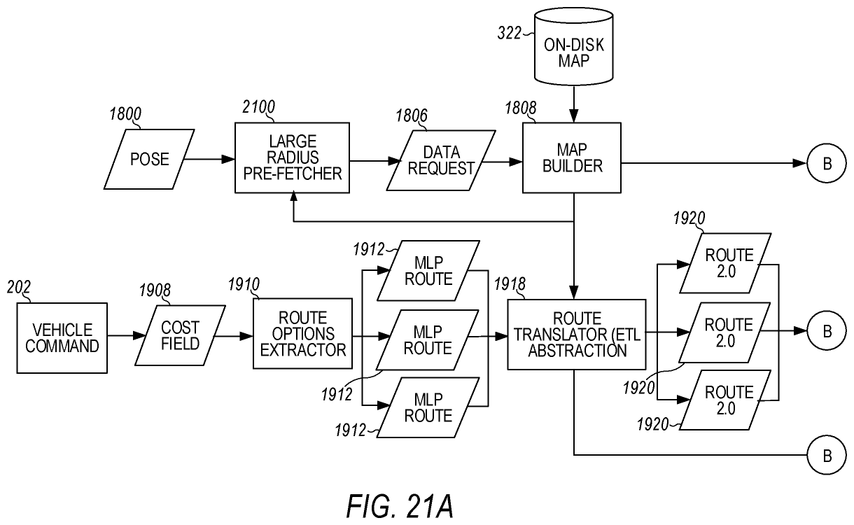

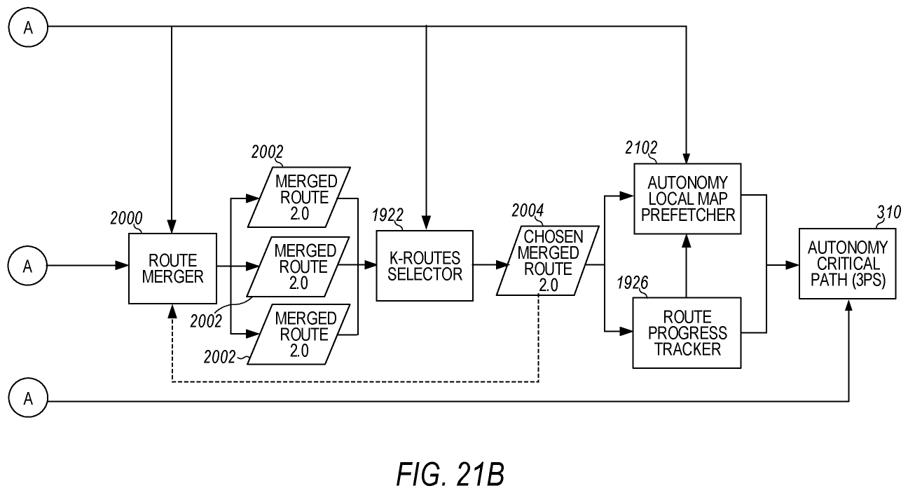

FIGS. 21A-21B together illustrate another alternative embodiment similar to that of FIGS. 20A-20B except that a large radius prefetcher 2100 prefetches a relatively large radius of map data that is processed into lane graphs by the map builder 1808. Also, an autonomy local map prefetcher 2102 selects a smaller map from the lane graphs built by the map builder 1808 based on the chosen route information for the vehicle 200.

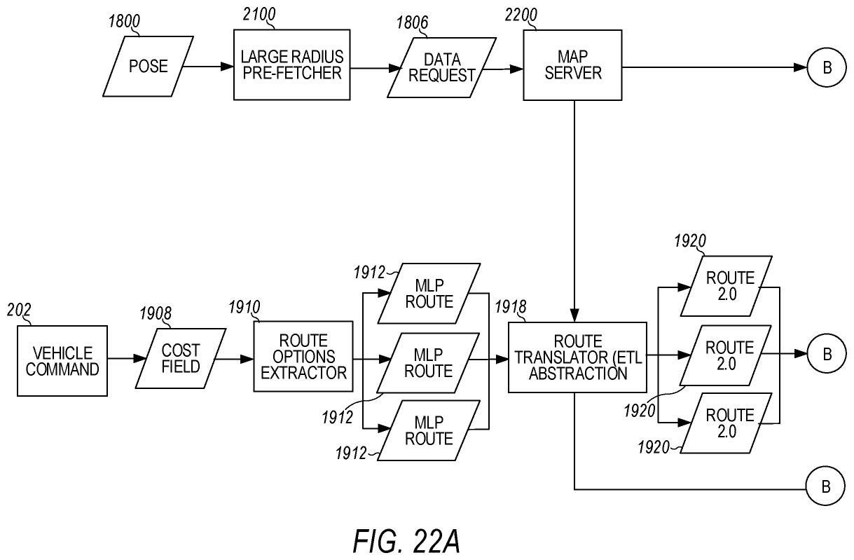

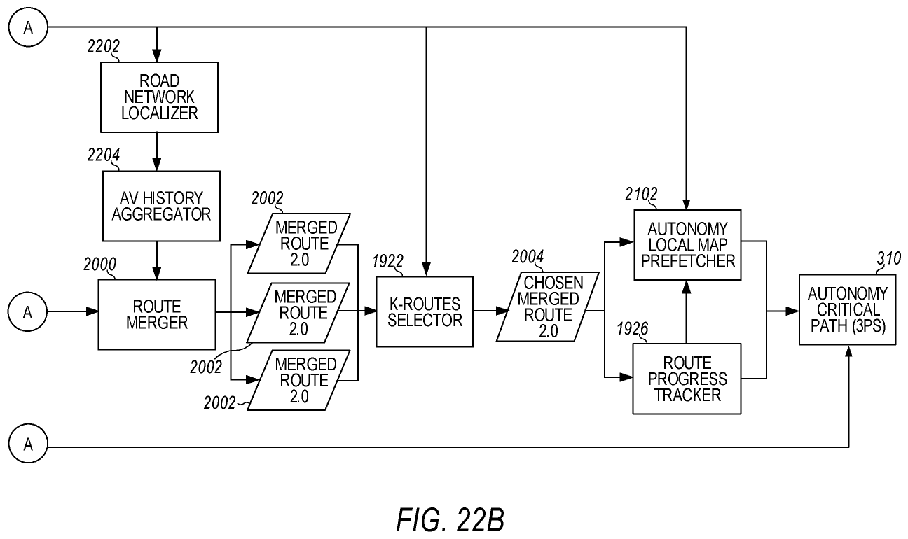

FIGS. 22A-22B together illustrate yet another alternative embodiment similar to that of FIGS. 20A-20B except that the previous route is not merged into the new route to get route history. Instead, pose is associated with observed map elements, which is used to build ground truth history as a sequence of lanes or roads. This is better than using the route, because it is robust to manual driving where the route may be ignored. The map server 2200 generates lane graphs for all or a significant portion of the on-disk map data so that the map data may be readily provided in response to queries. A road network localizer 2202 selects the map data in the proximity of the vehicle 200, while an AV history aggregator 2204 provides a rolling buffer (e.g., 50 m) of observed map data so that the more relevant map data may be made accessible to the vehicle 200 to minimize memory accesses.

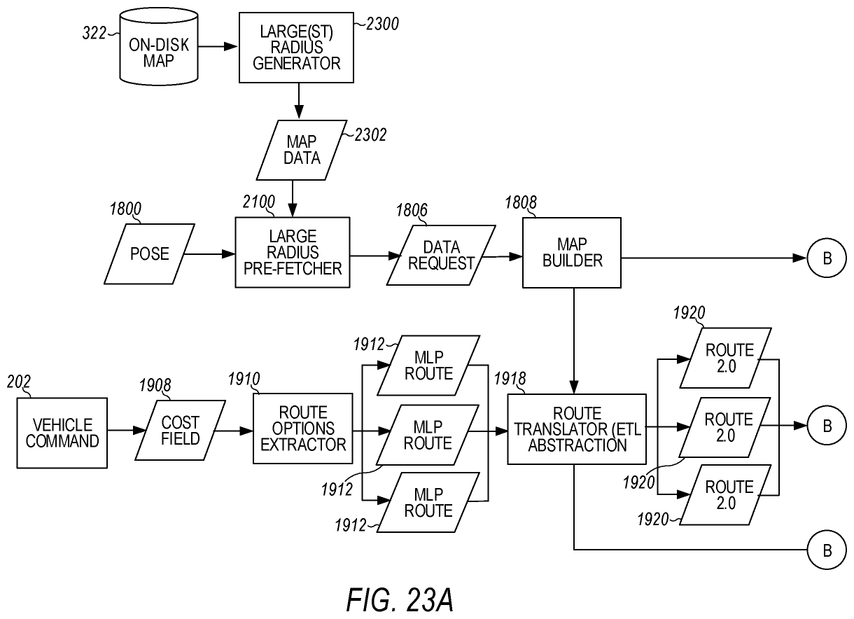

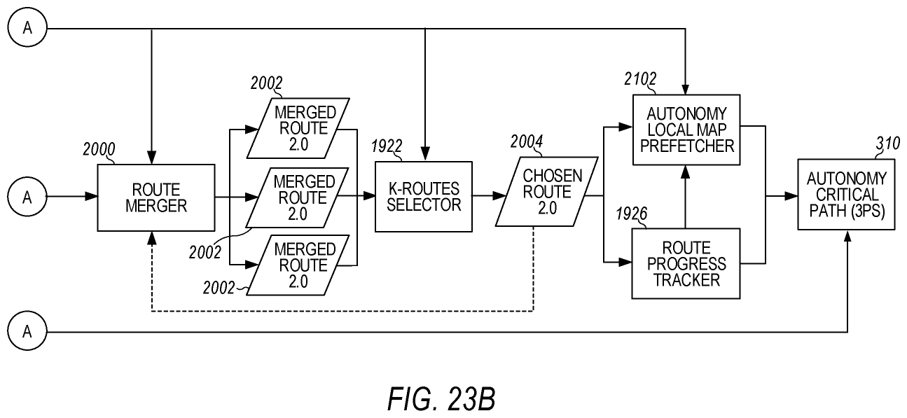

FIGS. 23A-23B together illustrate yet another alternative embodiment similar to that of FIGS. 20A-20B except that instead of requesting a radius of map data from a server that requires access to the on-disk map, one very large radius of map data is filtered through the system. All other users simply sub-sample this data blob and send out smaller radii rather than making a request for that smaller radii. Large radius map generator 2300 generates map data 2302 including lane graphs for pre-fetching by the large radius prefetcher 2100. The radius pre-fetcher requests a radius of map data and a buffer and then triggers another request when close to violating the buffer.

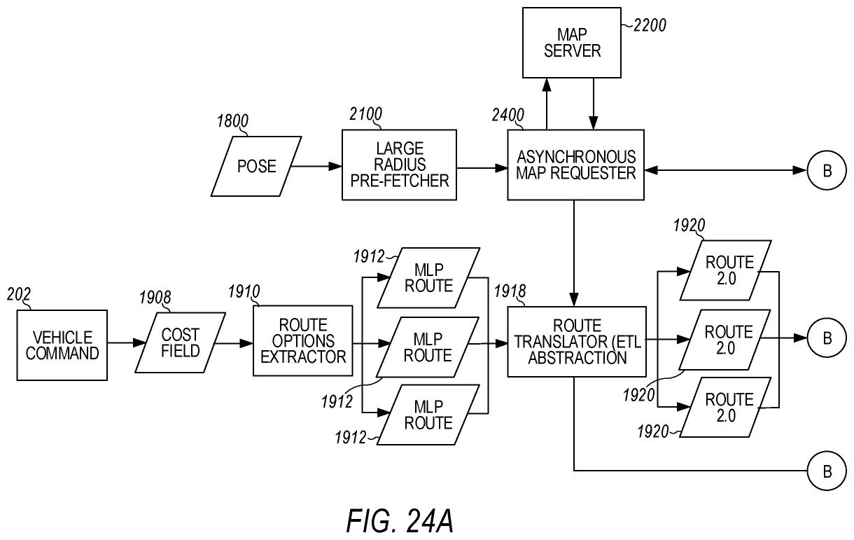

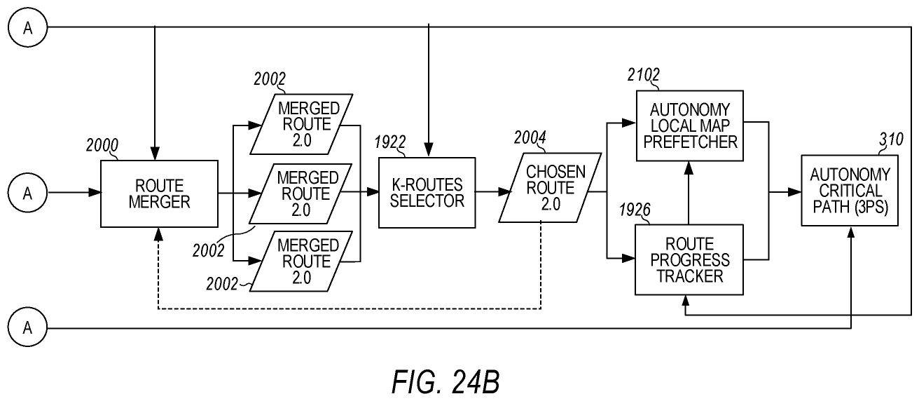

FIGS. 24-24B together illustrate yet another alternative embodiment similar to that of FIGS. 20A-20B except that the partition server is a remote procedure call (RPC) server. The asynchronous map requester 2400 interfaces with the map server 2200 to asynchronously select the map data based on the progress of the vehicle along the route as updated by route progress tracker 1926.

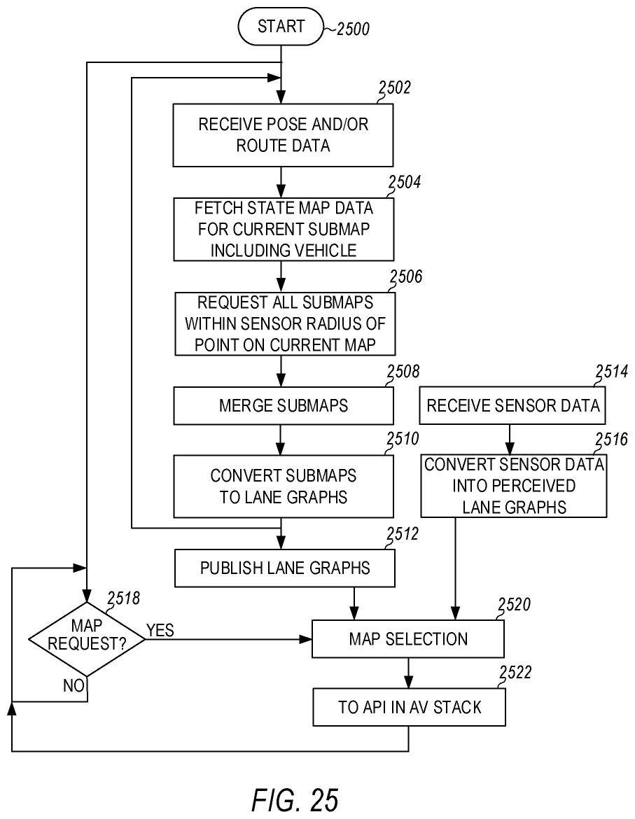

FIG. 25 illustrates a sample process flow of the local map server and multiplexer described herein in sample embodiments. As illustrated, the process starts at 2500 by receiving pose and/or route data from the pose and/or routing systems of the vehicle at 2502. In the case of pose data, map data for a current submap including the vehicle is requested from the static map memory based on the pose data at 2504. At least one point from is derived from the received current submap data and all submaps within a predetermined sensor radius of the at least one point are requested at 2506. The submap responses are merged at 2508 and converted to lane graphs at 2510 by generating a submap-to-submap transform graph for submaps generated from the static map data and transforming the submap-to-submap transform graph into a continuous coordinate frame by using a current vehicle pose containing transformations from the vehicle to the merged submaps and continuous coordinate frame to query the submap-to-submap transform graph used to generate the merged submaps to move from a reference submap to the merged submaps. The merged submaps/lane graphs are published at 2512 and available for query. On the other hand, when route data is provided, a sub-region of interest along the route is identified and steps 2504-2512 are repeated for multiple submaps in the sub-region of interest along the route based on the pose data. At least one geometric point from each received submap is identified at 2506 and all submaps within a predetermined sensor radius of the at least one geometric point are requested for each received submap.

During operation, the vehicle continuously receives sensor data at 2514 that is converted into perceived lane graphs at 2516.

Upon receipt of a map request from an API of the AV stack at 2518, either the lane graphs published at 2512 or the perceived lane graphs generated at 216 are selected for response to the map request and provided to the API stack at 2522. As note above with respect to FIG. 17, the local map multiplexer 330 enables selection of either the local map generated from the static map data. or from the perceived data based upon whether the local map data derived from the static map data and the perceived data differ from each other. For example, if differences are detected, the perceived map data is provided at 2520 under the assumption that the static map is incorrect due to construction, and the like. Then, once the SLA is verified to be valid for the static map data, the multiplexer may switch back to the static map data from the perceived map data and the map selection at 2520 would thereafter provide the static map data. The process of FIG. 25 would repeat throughout the operation of the autonomous vehicle.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

FIG. 26 is a block diagram 2600 showing one example of a software architecture 2602 for a computing device. The software architecture 2602 may be used in conjunction with various hardware architectures, for example, as described herein. FIG. 26 is merely a non-limiting example of a software architecture 2602 and many other architectures may be implemented to facilitate the functionality described herein. A representative hardware layer 2604 is illustrated and can represent, for example, any of the above-referenced computing devices. In some examples, the hardware layer 2604 may be implemented according to an architecture 2700 of FIG. 27 and/or the architecture 2602 of FIG. 26.

The representative hardware layer 2604 comprises one or more processing units 2606 having associated executable instructions 2608. The executable instructions 2608 represent the executable instructions of the software architecture 2602, including implementation of the methods, modules, components, and so forth of FIGS. 1-25. The hardware layer 2604 also includes memory and/or storage modules 2610, which also have the executable instructions 2608. The hardware layer 2604 may also comprise other hardware 2612, which represents any other hardware of the hardware layer 2604, such as the other hardware illustrated as part of the architecture 2700 in FIG. 27.

In the example architecture of FIG. 26, the software architecture 2602 may be conceptualized as a stack of layers where each layer provides particular functionality. For example, the software architecture 2602 may include layers such as an operating system 2614, libraries 2616, frameworks/middleware 2618, applications 2620, and a presentation layer 2644. Operationally, the applications 2620 and/or other components within the layers may invoke API calls 2624 through the software stack and receive a response, returned values, and so forth illustrated as messages 2626 in response to the API calls 2624L The layers illustrated are representative in nature and not all software architectures have all layers. For example, some mobile or special-purpose operating systems may not provide a framneworks/middleware 2618 layer, while others may provide such a layer. Other software architectures may include additional or different layers.

The operating system 2614 may manage hardware resources and provide common services. The operating system 2614 may include, for example, a kernel 2628, services 2630, and drivers 2632. The kernel 2628 may act as an abstraction layer between the hardware and the other software layers. For example, the kernel 2628 may be responsible for memory management, processor management (e.g., scheduling), component management, networking, security settings, and so on. The services 2630 may provide other common services for the other software layers. In some examples, the services 2630 include an interrupt service. The interrupt service may detect the receipt of a hardware or software interrupt and, in response, cause the software architecture 2602 to pause its current processing and execute an interrupt Service Routine (ISR) when an interrupt is received. The ISR may generate an alert.

The drivers 2632 may be responsible for controlling or interfacing with the underlying hardware. For instance, the drivers 2632 may include display drivers, camera drivers, Bluetooth® drivers, flash memory drivers, serial communication drivers Universal Serial Bus (USB) drivers), Wi-Fi® drivers, NFC drivers, audio drivers, power management drivers, and so forth depending on the hardware configuration

The libraries 2616 may provide a common infrastructure that may he utilized by the applications 262.0 and/or other components and/or layers. The libraries 2616 typically provide functionality that allows other software modules to perform tasks in an easier fashion than by interfacing directly with the underlying operating system 2614 functionality (e.g., kernel 2628, services 2630, and/or drivers 2632). The libraries 2616 may include system libraries 2634 (e.g., C standard library) that may provide functions such as memory allocation functions, string manipulation functions, mathematic functions, and the like. In addition, the libraries 2616 may include API libraries 2636 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., Web Kit that may provide web browsing functionality), and the like. The libraries 2616 may also include a wide variety of other libraries 2638 to provide many other APIs to the applications 2620 and other software components/modules.

The frameworks 2618 (also sometimes referred to as middleware) may provide a higher-level common infrastructure that may be utilized by the applications 2620 and/or other software components/modules. For example, the frameworks 2618 may provide various graphical user interface (GUI) functions, high-level resource management, high-level location services, and so forth. The frameworks 2618 may provide a broad spectrum of other APIs that may be utilized by the applications 2620 and/or other software components/modules, some of which may be specific to a particular operating system or platform.

The applications 2620 include built-in applications 2640 and/or third-party applications 2642. Examples of representative built-in applications 2640 may include, but are not limited to, a contacts application, a browser application, a book reader application, a location application, a media application, a messaging application, and/or a game application. The third-party applications 2642 may include any of the built-in applications 2640 as well as a broad assortment of other applications. In a specific example, the third-party application 2642 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 2642 may invoke the API calls 2624 provided by the mobile operating system such as the operating system 2614 to facilitate functionality described herein.

The applications 2620 may utilize built-in operating system functions (e.g., kernel 2628, services 2630, and/or drivers 2632), libraries (e.g., system libraries 2634, API libraries 2636, and other libraries 2638), or frameworks/middleware 2618 to create user interfaces to interact with users of the system. Alternatively, or additionally, in some systems, interactions with a user may occur through a presentation layer, such as the presentation layer 2644. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 26, this is illustrated by a virtual machine 2648. A virtual machine creates a software environment where applications/modules can execute as if they were executing on a hardware computing device. The virtual machine 2648 is hosted by a host operating system (e,g., the operating system 2614) and typically, although not always, has a virtual machine monitor 2646, which manages the operation of the virtual machine 2648 as well as the interface with the host operating system (e.g., the operating system 2614). A software architecture executes within the virtual machine 2648, such as an operating system 2650, libraries 2652, frameworks/middleware 2654, applications 2656, and/or a presentation layer 2658. These layers of software architecture executing within the virtual machine 2648 can be the same as corresponding layers previously described or may be different.

FIG. 27 is a block diagram illustrating a computing device hardware architecture 2700, within which a set or sequence of instructions can be executed to cause a machine to perform examples of any one of the methodologies discussed herein. The architecture 2700 may describe, a computing device for executing the local map server and multiplexer described herein.

The architecture 2700 may operate as a standalone device or may be connected (e.g., networked) to other machines. In a networked deployment, the architecture 2700 may operate in the capacity of either a server or a client machine in server-client network environments, or it may act as a peer machine in peer-to-peer (or distributed) network environments. The architecture 2700 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 2700 includes a processor unit 2702 comprising at least one processor (e.g., a central processing unit (CPU), a graphics processing unit (GPU), or both, processor cores, compute nodes, etc.) The architecture 2700 may further comprise a main memory 2704 and a static memory 2706, which communicate with each other via a link 2708 (e.g., bus). The architecture 2700 can further include a video display unit 2710, an input device 2712 (e.g., a keyboard), and a UI navigation device 2714 (e.g., a mouse). In some examples, the video display unit 2710, input device 2712, and UI navigation device 2714 are incorporated into a touchscreen display. The architecture 2700 may additionally include a storage device 2716 (e.g., a drive unit), a signal generation device 2718 (e.g., a speaker), a network interface device 2720, and one or more sensors (not shown), such as a Global Positioning System (GPS) sensor, compass, accelerometer, or other sensor.

In some examples, the processor unit 2702 or another suitable hardware component may support a hardware interrupt. In response to a hardware interrupt, the processor unit 2702 may pause its processing and execute an ISR, for example, as described herein.

The storage device 2716 includes a machine-readable medium 2722 on which is stored one or more sets of data structures and instructions 2724 (e.g., software) embodying or utilized by any one or more of the methodologies or functions described herein. The instructions 2724 can also reside, completely or at least partially, within the main memory 2704, within the static memory 2706, and/or within the processor unit 2702 during execution thereof by the architecture 2700, with the main memory 2704, the static memory 2706, and the processor unit 2702 also constituting machine-readable media.

### Executable Instructions and Machine-Storage Medium

The various memories (i.e., 2704, 2706, and/or memory of the processor unit(s) 2702) and/or storage device 2716 may store one or more sets of instructions and data structures (e.g., instructions) 2724 embodying or utilized by any one or more of the methodologies or functions described herein. These instructions, when executed by processor unit(s) 2702 cause various operations to implement the disclosed examples.

As used herein, the terms “machine-storage medium,” “device-storage medium,” “computer-storage medium” (referred to collectively as “machine-storage medium 2722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 2722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 2722 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 2724 can further be transmitted or received over a communications network 2726 using a transmission medium via the network interface device 2720 utilizing any one of a number of well-known transfer protocols (e.g., HTTP). Examples of communication networks include a LAN, a WAN, the Internet, mobile telephone networks, plain old telephone service (POTS) networks, and wireless data networks (e.g., 3G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of such features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

1. A system for providing map data to a vehicle, comprising:
a static map memory that stores static map data;
a map relative pose dependent server that generates submaps from the static map data based on at least one of pose and route information for the vehicle;
sensors that provide environmental data as perception data;
an application program interface that generates map requests; and
a multiplexer that enables selection of at least one of the generated submaps and the perception data in response to a map request.

2. The system of claim 1, wherein the map relative pose dependent server comprises at least one processor unit and a machine-readable medium comprising instructions thereon that, when executed by the at least one processor unit, causes the at least one processor unit to perform operations comprising:
receiving pose data from a pose state estimator;
requesting map data for a current submap including the vehicle based on the pose data;
deriving at least one point from received current submap data and requesting all submaps within a predetermined sensor radius of the at least one point; and
merging all submap responses together and publishing the merged submaps as a response message to the map request.

3. The system of claim 2, wherein the machine-readable medium further comprises instructions thereon that, when executed by the at least one processor unit, causes the at least one processor unit to perform operations comprising:
receiving a route from a vehicle command system;
identifying a sub-region of interest along the route;
receiving pose data from a pose state estimator;
requesting map data for multiple submaps in a sub-region of interest along the route based on the pose data;
deriving at least one geometric point from each received submap data and requesting all submaps within a predetermined sensor radius of the at least one geometric point for each received submap; and
merging all submap responses together and publishing the merged submaps as a response message to the map request.

4. The system of claim 1, wherein the machine-readable medium further comprises instructions thereon that, when executed by the at least one processor unit, causes the at least one processor unit to convert the submaps to lane graphs and to provide the lane graphs in response to the map request.

5. The system of claim 1, wherein the machine-readable medium further comprises instructions thereon that, when executed by the at least one processor unit, causes the at least one processor unit to generate a submap-to-submap transform graph that supplies transforms from each submap's reference frame to any directly neighboring submap's reference frame, the submap-to-submap transform graph facilitating transforming all map data into a reference frame of a single submap specified by a vehicle localization, which synchronizes a vehicle relative pose with a submap relative pose, thus describing the transform from the submap's reference frame to the vehicle's reference frame and allowing transforming an entirety of local map data into the vehicle's reference frame.

6. The system of claim 1, wherein the application program interface generates map requests on behalf of an autonomous vehicle stack comprising at least one of a perception stack, a prediction stack, and a motion planning stack for an autonomous vehicle.

7. The system of claim 1, wherein the multiplexer compares the generated submaps and the perception data in response to a map request and provides the perception data when the generated submaps do not match the perception data.

8. The system of claim 1, wherein the machine-readable medium further comprises instructions thereon that, when executed by the at least one processor unit, causes the at least one processor unit to generate a perceived local map from perception data from the sensors and to provide the perceived local map to the multiplexer.

9. The system of claim 8, wherein the machine-readable medium further comprises instructions thereon that, when executed by the at least one processor unit, causes the at least one processor unit to generate a perceived lane graph from lanes detected by the sensors.

10. The system of claim 9, wherein the multiplexer merges the generated submaps and the perceived lane graph in response to the map request.

11. The system of claim 1, wherein the map relative pose dependent server comprises a map requester that requests static map data from the static map memory based on at least one of pose and route information for the vehicle and a map builder that merges the requested static map data into submaps and generates a response message including the merged submaps in response to the map request.

12. The system of claim 1, wherein the map relative pose dependent server comprises a large radius map requester that requests a large radius map centered around the vehicle, a map builder that converts received large radius map data into lane graphs, an autonomy radius map requester that determines when to re-request the map data from the map builder, a submap server that handles map requests from the application program interface, and a route translator that takes MLP lane described routes and turns them into driving lane segment described routes.

13. The system of claim 12, further comprising a route merger responsive to the map data to create merged routes for selection by a route selector of the motion planning stack of the autonomous vehicle.

14. The system of claim 1, wherein the map relative pose dependent server comprises a large radius map prefetcher that prefetches a large radius map centered around the vehicle, a map builder that converts received large radius map data into lane graphs, an autonomy local map prefetcher that prefetches map data from the map builder, a route translator that takes MLP lane described routes and turns them into driving lane segment described routes, and a route merger responsive to the map data to create merged routes for selection by a route selector of a motion planning stack of an autonomous vehicle.

15. The system of claim 14, further comprising a large radius map generator that generates lane graphs from static map data for prefetching by the large radius map prefetcher.

16. The system of claim 1, wherein the map relative pose dependent server comprises a large radius map prefetcher that prefetches a large radius map centered around the vehicle, a map server that converts received large radius map data into lane graphs, an autonomy local map prefetcher that prefetches map data from the map builder, a road network localizer that selects map data in a proximity of the vehicle, a route translator that takes MLP lane described routes and turns them into driving lane segment described routes, and a route merger responsive to the map data to create merged routes for selection by a route selector of a motion planning stack of an autonomous vehicle.

17. The system of claim 16, further comprising an asynchronous map requester that interfaces with the map server to asynchronously select the map data based on progress of the vehicle along a route.

18. A computer-implemented method of providing map data to a vehicle, comprising:
generating submaps from static map data based on at least one of pose and route information for the vehicle;
generating perception data from environmental data collected by sensors;
receiving map requests; and
selecting at least one of the generated submaps and the perception data in response to a map request.

19. The method of claim 18, further comprising:
receiving pose data from a pose state estimator;
requesting map data for a current submap including the vehicle based on the pose data;
deriving at least one point from received current submap data and requesting all submaps within a predetermined sensor radius of the at least one point;
merging all submap responses together; and
publishing the merged submaps as a response message to the map request.

20. The method of claim 19, further comprising:
receiving a route from a vehicle command system;
identifying a sub-region of interest along the route;
receiving pose data from a pose state estimator;
requesting map data for multiple submaps in a sub-region of interest along the route based on the pose data;
deriving at least one geometric point from each received submap data and requesting all submaps within a predetermined sensor radius of the at least one geometric point for each received submap;
merging all submap responses together; and
publishing the merged submaps as a response message to the map request.

21. The method of claim 18, further comprising converting the submaps to lane graphs and providing the lane graphs in response to the map request.

22. The method of claim 21, further comprising generating a submap-to-submap transform graph for submaps generated from the static map data and transforming the submap-to-submap transform graph into a continuous coordinate frame by using a current vehicle pose containing transformations from the vehicle to the merged submaps and continuous coordinate frame to query the submap-to-submap transform graph used to generate the merged submaps to move from a reference submap to the merged submaps.

23. A tangible machine-readable medium comprising instructions thereon that, when executed by at least one processor unit, causes the at least one processor unit to perform operations comprising:
generating submaps from static map data based on at least one of pose and route information for a vehicle;
generating perception data from environmental data collected by sensors;
receiving map requests; and
selecting at least one of the generated submaps and the perception data in response to a map request.
